(19) United States
(12) Patent Application Publication
(10) Pub. No.: US 2022/0372943 A1
(43) Pub. Date: Nov. 24, 2022

(54) RECOVERY OF WORK FROM A LIQUEFIED GAS USING HYBRID PROCESSING

(71) Applicant: Energy Internet Corporation, Saratoga, CA (US)

(72) Inventors: Shankar Nataraj, Allentown, PA (US); Paul M. Mathias, Aliso Viejo, CA (US); Shankar Ramamurthy, Saratoga, CA (US); Steven F. Sciamanna, Orinda, CA (US)

(21) Appl. No.: 17/876,650

(22) Filed: Jul. 29, 2022

Related U.S. Application Data
(63) Continuation-in-part of application No. 17/726,589, filed on Apr. 22, 2022.
Application No. 17/726,589 is a continuation-in-part of application No. 16/747,843, filed on Jan. 21, 2020.
Application No. 16/747,843 is a continuation-in-part of application No. 16/378,243, filed on Apr. 8, 2019, now Pat. No. 10,947,899.
Application No. 16/378,243 is a continuation-in-part of application No. 16/118,886, filed on Aug. 31, 2018, now Pat. No. 10,725,441.
(60) Provisional application No. 63/358,699, filed on Jul. 6, 2022.
(60) Provisional application No. 63/316,432, filed on Mar. 4, 2022.
(60) Provisional application No. 63/246,813, filed on Sep. 22, 2021.
(60) Provisional application No. 63/227,499, filed on Jul. 30, 2021.
(60) Provisional application No. 63/178,560, filed on Apr. 23, 2021.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.

(51) Int. Cl. F03B 3/04; F03B 13/00; F04B 19/04

(52) U.S. Cl. CPC F03B 3/04; F03B 13/00; F04B 19/04

(57) ABSTRACT

Disclosed techniques include working fluid exergy recovery using hybrid processing. A supply of working fluid at a first pressure and a first temperature is accessed. The working fluid is compressed. The compressing yields the working fluid at a second pressure. The second pressure is greater than the first pressure. The working fluid at the second pressure and a second temperature is warmed using a first heat exchanger. The second temperature is greater than the first temperature. The working fluid at the second temperature is in a gaseous state. The working fluid is expanded in a gaseous state to a third pressure. The expanding is accomplished using a first liquid piston expander. An engine is driven to recover work from the working fluid in a gaseous state. The engine is powered by liquid from the first liquid piston expander.

### RELATED APPLICATIONS

This application claims the benefit of U.S. provisional patent applications “Recovery of Work from a Liquefied Gas Using Hybrid Processing” Ser. No. 63/227,499, filed Jul. 30, 2021, “Hybrid Compressed Air Energy Storage System Using Paired Liquid Pistons” Ser. No. 63/246,813, filed Sep. 22, 2021, “Hybrid Compressed Air Energy System Using Liquid Pistons” Ser. No. 63/316,432, filed Mar. 4, 2022, and “Gas Processing Using Hydrogen And Ammonia” Ser. No. 63/358,699, filed Jul. 6, 2022.

This application is also a continuation-in-part of U.S. patent application “Gas Liquefaction Using Hybrid Processing” Ser. No. 17/726,589, filed Apr. 22, 2022, which claims the benefit of U.S. provisional patent applications “Gas Liquefaction Using Hybrid Processing” Ser. No. 63/178,560, filed Apr. 23, 2021, “Recovery of Work from a Liquefied Gas Using Hybrid Processing” Ser. No. 63/227,499, filed Jul. 30, 2021, “Hybrid Compressed Air Energy Storage System Using Paired Liquid Pistons” Ser. No. 63/246,813, filed Sep. 22, 2021, and “Hybrid Compressed Air Energy System Using Liquid Pistons” Ser. No. 63/316,432, filed Mar. 4, 2022.

The U.S. patent application “Gas Liquefaction Using Hybrid Processing” Ser. No. 17/726,589, filed Apr. 22, 2022 is also a continuation-in-part of U.S. patent application “Energy Management Using a Converged Infrastructure” Ser. No. 16/747,843, filed Jan. 21, 2020, which claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

The U.S. patent application “Energy Management Using a Converged Infrastructure” Ser. No. 16/747,843, filed Jan. 21, 2020 is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to gas processing and more particularly to recovery of work from a liquefied gas using hybrid processing.

### BACKGROUND

As municipalities, counties, states, and countries continue to grow, so does the demand for energy in various forms. Demands for electricity, fuel for vehicles, etc., increase greatly as standards of living improve and transportation networks expand. While some countries actively undertake dramatic steps to reduce energy demand and to revamp energy infrastructures, others are constructing fossil fuel power plants, nuclear facilities, hydroelectric dams, and other traditional and often controversial energy generation sources. The development of rural and previously underserved areas further increases energy demand, requiring the installation of electrical and communications infrastructures and the expansion of transportation networks. Growing populations further consume energy for cooking, bathing, cleaning, laundry, and entertaining. Energy is additionally consumed for illuminating, heating, and cooling houses or apartments, businesses, and government buildings. Expanded economic activities, including retail, public transportation, and manufacturing, among many others, further increase energy demand.

Numerous energy stakeholders, including government agencies, energy producers, and conservation minded consumers big and small, actively seek to reduce energy consumption. These parties are motivated to craft, initiate, practice, and enforce energy conservation measures for environmental and economic reasons. Consumers can decrease their energy footprints by altering their heating and cooling habits; turning off unneeded lights; and purchasing energy-efficient appliances, electronics, and automobiles. Each of these measures achieves simple energy conservation and reduced cost. Yet, the demand for energy of all types outstrips conservation savings alone. The growth drives the demand for energy of all kinds, resulting in what many analysts label an energy crisis. Increasing energy demand has many dimensions. Increased demand and overconsumption of energy impose strains on natural resources and renewable resources alike, resulting in fuel shortages, rising energy costs, and increased environmental damage.

Energy distribution remains a difficult bottleneck to progress. The existing energy distribution infrastructure can be overburdened. Further, the infrastructure is often unavailable to potential new energy sources including renewable energy, which remains largely unexplored or underdeveloped. There is vociferous objection by adjacent landowners and others to the siting of mountaintop or offshore wind turbines, solar farms, or wood burning plants. Even when designs can be drafted and permits obtained to construct renewable energy producing facilities, the distribution of the energy is impeded by the poor distribution infrastructure. Landowners are reluctant to agree to high tension lines traversing their property, particularly when the power is destined for consumers “from away”. Commissioning new energy generation facilities remains a seemingly insurmountable challenge. Energy loss and wastage further remain major impediments. Aging appliances or manufacturing equipment, incandescent light bulbs, and poor building insulation and air sealing all waste energy in comparison to their modern counterparts. Public officials, planners, and others are compelled to choose among three broad energy solutions: to increase energy production, to reduce energy demand through energy conservation, or to implement a combination of both of these strategies.

### SUMMARY

Traditional, alternative, and renewable generation sources are used to produce energy. Energy consumption fluctuates over a given period of time, resulting in dynamic differences between energy production and energy consumption. The differences can further depend on a timeframe such as day versus night, a day of the week, manufacturing schedules, financial processing, seasonal factors such as heating or cooling, and so on. The discrepancies between energy production and energy consumption can be substantial and at times acute. The discrepancies can be correlated to time-dependent energy demands; to fluctuating energy production capabilities, such as the presence or absence of renewable resources; to available capacity of commercial or grid power; to the amount of standby or backup energy; etc. To ameliorate the dynamic asymmetry between energy production and consumption, energy that is in excess to demand at a given time can be stored for later use. The stored energy can be recovered later when demand exceeds a given power level or supply capability. Energy can be collected and stored when a renewable resource is available, when the available energy exceeds energy need, or even when the cost of production of the energy is relatively inexpensive. The stored energy can be used to augment available energy or to provide the amount of energy that is needed during periods of increased or otherwise unmet energy need. The recovery of stored energy can be applied to low-level energy demand scenarios, such as the energy needs of a house or small farm operation, to larger scale energy needs, such as the energy needs for manufacturing, or even to the largest energy needs, such as an energy distribution grid.

Disclosed techniques address liquefied gas or working fluid exergy recovery using hybrid processing. A supply of working fluid at a first pressure and a first temperature is accessed. The working fluid that is accessed can include a working fluid at a low pressure. The working fluid is compressed using a biphasic pressurizer. The compressing the working fluid yields the working fluid at a second pressure, where the second pressure is greater than the first pressure. The working fluid at the second pressure is warmed to a second temperature using a first heat exchanger. The second temperature is greater than the first temperature, and the working fluid at the second temperature is in a gaseous state. The working fluid in a gaseous state is expanded to a third pressure. The expanding is accomplished using a first liquid piston expander. A second liquid piston expander can be daisy-chained between the first liquid piston expander and a second heat exchanger. An engine is driven to recover work from the working fluid in a gaseous state. The engine is powered by liquid from the first liquid piston expander.

A computer-implemented method for gas processing is disclosed comprising: accessing a supply of working fluid at a first pressure and a first temperature; compressing the working fluid, wherein the compressing yields the working fluid at a second pressure, wherein the second pressure is greater than the first pressure; warming the working fluid at the second pressure to a second temperature using a first heat exchanger, wherein the second temperature is greater than the first temperature, wherein the working fluid at the second temperature is in a gaseous state; expanding the working fluid in a gaseous state to a third pressure, wherein the expanding is accomplished using a first liquid piston expander; and driving an engine to recover work from the working fluid in a gaseous state, wherein the engine is powered by liquid from the first liquid piston expander. The method further includes warming the working fluid in a gaseous state in the first liquid piston expander to enable substantially isothermal expansion. The warming can be accomplished using a liquid spray, wherein the liquid spray comprises a liquid spray heated by heat stored in a thermal store. The heat stored in the thermal store was generated by a process that produced the supply of working fluid. The method further includes warming the working fluid in a gaseous state that was expanded to a third pressure in a second heat exchanger. The second heat exchanger is fed by gas from the first liquid piston expander. The method further includes additionally expanding the gas from the first liquid piston expander that was heated by the second heat exchanger to a fourth pressure. The additionally expanding the gas from the first liquid piston expander that was heated by the second heat exchanger to a fourth pressure is used to recover additional work from the supply of working fluid. The method further includes pressurizing an auxiliary gas, wherein the auxiliary gas is mixed with the supply of working fluid.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for working fluid work recovery using hybrid processing.

FIG. 2 is a flow diagram for driving an additional engine.

FIG. 3 is an infographic diagram of a liquid piston expander (LPE).

FIG. 4 illustrates liquid piston-based (LP-based) work extraction.

FIG. 5 shows hybrid expansion.

FIG. 6 illustrates a block diagram for a biphasic pressurizer.

FIG. 7 shows exergy recovery from liquefied air.

FIG. 8 illustrates enhancement of exergy recovery from liquefied air using a liquid piston and dryer.

FIG. 9 shows enhanced exergy recovery with hybrid expansion.

FIG. 10 illustrates hybrid multistage liquid piston expansion.

FIG. 11 shows a multistage exergetic loop.

FIG. 12 illustrates a liquid piston-based exergetic loop.

FIG. 13 shows working fluid work recovery using hybrid processing.

FIG. 14 is a system diagram for working fluid work recovery using hybrid processing.

### DETAILED DESCRIPTION

This disclosure provides techniques for working fluid exergy, or work, recovery using hybrid processing. Gas processing can be managed, where the gas processing can include liquefying a gas, storing the liquefied gas or working fluid, capturing heat generated when processing the gas, vaporizing a working fluid, and extracting or recovering exergy or work from the gas. The exergy or work extracted from the working fluid can be converted to another energy type such as electrical energy. Energy management includes storing energy such as grid energy, renewable energy, and so on, using a working fluid. The working fluid can be stored in a vessel such as a high pressure vessel, a holding tank such as a cryogenic tank, etc. Liquids have much higher density compared to gases at comparable (sub-critical) pressures, thus storing a working fluid in its liquid state or phase consumes less volume. For example, a working fluid such as air is in a liquid state only below −140.5° C., which puts it in the cryogenic range. Such liquids can be stored in cryogenic dewars or tanks. A holding tank can be part of a large-scale energy storage subsystem, which can store energy from one or more points of generation. The stored energy can be provided after a period of time to meet unmet energy demands such as energy demands of dynamic loads. The exergy or potential work that is stored using the working fluid can be received from diverse and disparate energy sources. Energy can be shaved or harvested and stored when the amount of energy available from the points of generation exceeds the energy demand at the time of energy generation. The energy can be stored for a period of time. The energy storage includes electrical energy storage using batteries or capacitors. The energy storage can include multiple pressurized storage elements such as compressed air storage elements. The energy storage includes the one or more working fluids within a holding tank.

The exergy or potential work stored in the working fluid can be recovered and converted to another energy form such as mechanical energy, electrical energy, and so on. The energy can be stored and recovered using a liquid piston (LP), a water piston heat engine (WPHE), inter-heated compressors and expanders, and so on. Managing the recovery of exergy, while minimizing lost work, is a complex and highly challenging task. Energy management can be influenced by many factors including the weather, dynamic energy demands, variable pricing schemes, and the like. Energy management can be further complicated by fluctuating and at times wildly varying customer energy demands, contractual requirements of service level agreements (SLAs), etc. Despite the growing use of renewable energy resources such as solar, wind, wave action, tidal, geothermal, biogas, biomass, and the like, significant challenges remain: the amount of energy produced by a given renewable energy source is highly variable, the availability of the renewable energy source is inconsistent, and the efficient recovery of the stored energy is highly challenging.

Excess energy or energy with intermittent availability can be stored or cached when the energy is being produced, and can be extracted or recovered at a later time when the stored energy is needed to meet demand. A further strategy can be used based on price, where energy is stored when production cost is low and supply is in excess to demand, then later extracted when the energy production cost is high. The stored energy can be used in various combinations with other energy sources such as grid power or locally generated “microgrid” power to meet energy demands at given times. Energy storage can be based on a period of time, where the period of time can be a short-term basis or a long-term basis. As with all physical systems, energy losses are introduced throughout a system that converts energy from one energy type to a second energy type, then converts the second energy type back to the first or other energy type. Losses also occur when storing, routing, or otherwise handling energy, and further losses occur when extracting energy from its stored form. Minimizing the energy losses is critical to any energy storage and recovery/extraction/retrieval technique. Electrical energy storage is possible using techniques such as mature storage battery technologies, but the costs of large battery banks are prohibitive in terms of both up-front expense and maintenance costs. Further, batteries are problematic for long-term storage purposes because of charge leakage. Electrical energy can be produced by recovering work from the stored energy.

In disclosed techniques, working fluid exergy recovery uses hybrid processing. Excess or intermittent energy can be captured, converted to another energy form such as a working fluid, and stored for later use. The energy can be obtained locally using an onsite microgrid, or from farther afield using a larger grid such as a regional or national grid. The energy can be generated using fossil fuels or nuclear sources; using hydro power or geothermal energy; using renewable sources such as solar, wind, tidal, wave action, biofuels, or biogas; using pump-turbine sources such as compressed air, steam, or ice; using backup power sources such as diesel-generator sets; and so on. The stored exergy can be converted to a desired energy form, such as electrical energy, by recovering energy from the working fluid or other storage medium. Exergy recovery includes accessing a supply of working fluid at a first pressure and a first temperature. The first pressure can include a low pressure. The working fluid can include liquefied air. The working fluid is compressed. The compressing of the working fluid yields the working fluid at a second pressure, wherein the second pressure is greater than the first pressure. The working fluid at the second pressure is warmed to a second temperature using a first heat exchanger. The second temperature is greater than the first temperature. The working fluid at the second temperature is in a gaseous state. The gas that results from warming the working fluid comprises the working fluid in a gaseous state. Note that the disclosed techniques describe recovering work from a working fluid that is in a liquid or liquefied state, and that processing the working fluid in a liquefied state can lead to the working fluid being changed to supercritical or gaseous states. The working fluid in a gaseous state is expanded to a third pressure. The expanding is accomplished using a first liquid piston expander. An engine is driven to recover work from the working fluid in a gaseous state. The engine is powered by liquid from the first liquid piston expander.

Exergy recovery from working fluid can be based on requirements including energy storage capacity, conversion efficiency, extraction efficiency, and so on. Exergy can be recovered from working fluid using a working fluid processing system. The working fluid processing system can access, compress, warm, and expand the gas. The expanded gas can be used to drive an engine to recover work from the working fluid. Generating work by expanding a gas can cause its temperature to fall; heat exchangers can be used to warm the expanded and cooled gas. The warming can further be accomplished in one or more liquid piston expanders. The warming can be achieved by using a liquid spray, where the liquid spray can be heated by heat stored in a thermal store. The heat stored in the thermal store was generated by a process that produced the supply of liquefied gas. The working fluid from which work is recovered can be stored in a storage vessel such as a cryogenic tank. Since heat can be generated by compression of a gas as part of a liquefaction process, the heat can be extracted and can be stored in a thermal store such as a bed of packing, a heat exchanger filled with a heat-storing liquid, etc. The working fluid processing system used to recover exergy from the working fluid can be part of a larger energy management system that includes one or more large-scale energy storage and extraction subsystems. The large-scale energy storage and extraction subsystem can store and extract electrical energy, potential energy, thermal energy, kinetic energy, etc.

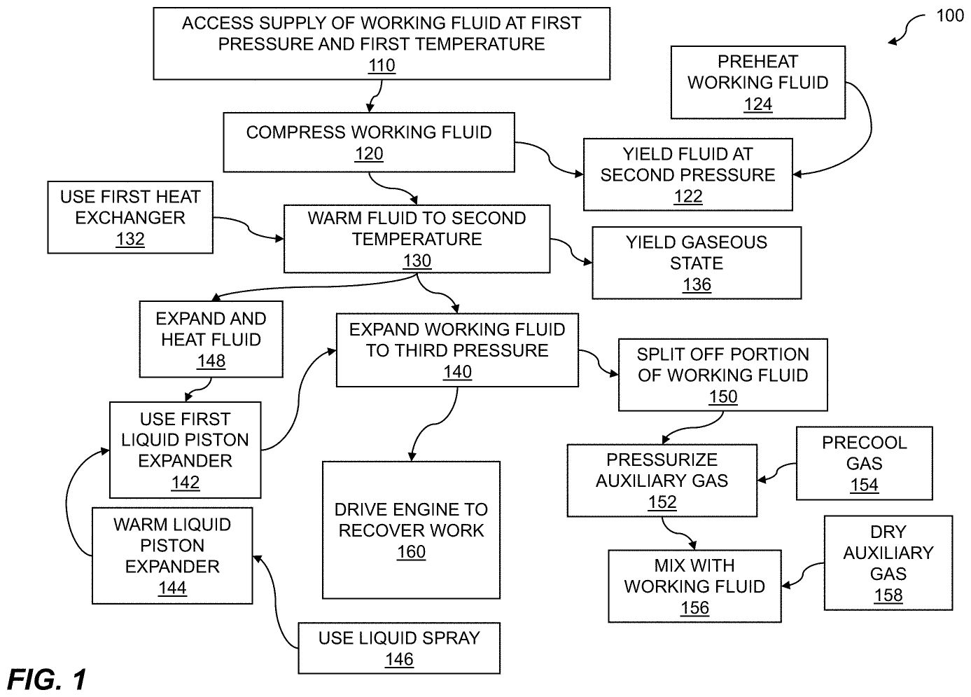

FIG. 1 is a flow diagram for working fluid work recovery using hybrid processing. Gas liquefaction techniques can enable exergy storage, recovery, and management. A gas liquefaction subsystem can store various forms of energy such as electrical energy or mechanical energy by storing the exergy as one or more working fluids. The working fluid can be stored in holding tanks such as cryogenic holding tanks. The exergy can be stored and recovered based on a liquid phase of the gas that is being compressed. The gas liquefaction energy management subsystem can be part of a large energy recovery subsystem, where the energy recovery subsystem can include multiple engines. The engines can include engines based on liquid piston expanders. A supply of working fluid at a first pressure and a first temperature is accessed. The working fluid is compressed. The compressing yields the working fluid at a second pressure, wherein the second pressure is greater than the first pressure. The working fluid at the second pressure is warmed to a second temperature using a first heat exchanger. The second temperature is greater than the first temperature and the working fluid at the second temperature is in a gaseous state. The working fluid in a gaseous state is expanded to a third pressure. The expanding is accomplished using a first liquid piston expander. An engine is driven to recover work from the working fluid in a gaseous state, wherein the engine is powered by liquid from the first liquid piston expander. Warming the working fluid in a gaseous state in the first liquid piston expander enables substantially isothermal expansion. The warming can be accomplished using a liquid spray.

A flow 100 for working fluid exergy recovery using hybrid processing is shown. Energy, such as electrical energy from a traditional electrical grid, energy from renewable sources, and so on, can be stored. Thermal energy, mechanical energy, pressure, and other forms of energy can also be stored. The energy can be transformed into an energy format which can be stored for a length of time. The energy can later be recovered to cover energy supply shortfalls, to provide energy at times of high energy cost, and the like. Energy management can direct the storing, retrieving, or extracting energy from an energy storage subsystem such as a gas liquefaction subsystem. The energy storage subsystem can be a large-scale energy storage subsystem or can be a small-scale energy storage subsystem. The energy storage subsystems can be based on battery storage, capacitor storage, inductive storage, compressed air storage, steam or ice storage, ice-water slurry, and so on. Described herein, energy recovery from the energy storage subsystem can include a working fluid exergy recovery subsystem based on hybrid processing. A gas liquefaction storage subsystem can include energy storage elements such as high-pressure chambers, compression-expansion chambers, compressed air chambers, one or more cryogenic vessels, and so on. The working fluid exergy recovery subsystem can include liquid piston expanders; inter-heated expanders; and a hybrid technique which is based on a combination of liquid piston expanders, expanders, and inter-heated expanders. The recovery elements of an energy storage subsystem can recover various energy types including electrical energy, thermal energy, kinetic energy, mechanical energy, hydraulic energy, and so on.

The flow 100 includes accessing a supply of working fluid at a first pressure and a first temperature 110. The working fluid can include liquefied air, liquefied nitrogen, liquefied natural gas, a combination of gases, and so on. In embodiments, the working fluid can include liquefied environmental air. The environmental air can be processed prior to liquefaction. The processing of the environmental air can include filtering, drying, etc. The first pressure associated with the supply of working fluid can include a low pressure. The first pressure can be any pressure below the critical pressure of the gas. In embodiments, the first pressure can be in the range of 1 to 40 atmospheres. The first temperature can be the boiling point of the working fluid at the pressure inside its storage tank. The first temperature will always be below ambient temperature, and can be at cryogenic temperatures. In embodiments, the second temperature is greater than or equal to ambient temperature. The flow 100 includes compressing the working fluid 120. The compressing of the working fluid can be accomplished using a pump, a pump-turbine, a liquid piston compressor, and so on. In the flow 100, the compressing yields the working fluid at a second pressure 122, wherein the second pressure is greater than the first pressure. In embodiments, the second pressure can be in the range of 40 to 200 atmospheres. The flow 100 further includes preheating 124 the working fluid at a second pressure using an additional heat exchanger that is warmed by an exergetic loop. The exergetic loop can use a liquid different from the working fluid from which work is recovered. The liquid within the exergetic loop can include a refrigerant such as a Freon™. In embodiments, the exergetic loop can include two or more expander stages with inter-stage heating elements. The inter-stage heating elements can include inter-heaters, as discussed throughout. In other embodiments, the exergetic loop comprises a liquid piston expander. The liquid piston expander can be used in place of an inter-heated expander, in addition to an inter-heated expander, and so on.

The flow 100 includes warming the working fluid at the second pressure to a second temperature 130. The second temperature can include a target temperature, a threshold temperature, etc. In embodiments, the second temperature can include an ambient temperature. The warming can be provided based on heat provided by an ambient temperature of an environment surrounding a warming component. The warming can be accomplished using a liquid spray (described shortly below). In the flow 100, the warming is accomplished using a first heat exchanger 132. In embodiments, the second temperature is greater than the first temperature, and the working fluid at the second temperature yields a gaseous state 136. The heat exchanger can include an air heat exchanger. The heat exchanger can be used to exchange heat between the working fluid and an exergetic loop. The exergetic loop (discussed below) can comprise an auto-exergetic loop, a self-contained exergetic loop, or a combination of the two. The flow 100 includes yielding the working fluid at the second temperature in a gaseous state.

The flow 100 includes expanding the working fluid in a gaseous state to a third pressure 140. The third pressure can be lower than the second pressure. In embodiments, the third pressure can be in the range of 1 to 50 atmospheres. The piston liquid can be under pressure due to the expanding the working fluid in a gaseous state to a third pressure. In the flow 100, the expanding is accomplished using a first liquid piston (LP) expander 142. The liquid piston expander comprises a vessel such as a pressure vessel, and valves such as switching valves that can control the inflow and outflow of a piston liquid and working fluid rendered to a gas into the pressure vessel. The pressure vessel can contain a gas, a working fluid, a liquid, and so on. The “liquid piston” is formed at an interface between gas and liquid within the pressure vessel. Adding fluid or liquid to the pressure vessel can cause the liquid to act as a piston to compress gas within the pressure vessel. The gas and the liquid used within the pressure vessel can be chosen to minimize mixing or dissolving of one into the other. A liquid piston expander can be used to expand a gas by reducing pressure within the vessel. In embodiments, the pressure within the vessel can be controlled by reducing an amount of gas, an amount of liquid, or both the amounts of gas and liquid within the vessel. Noting the Ideal Gas Law, PV=nRT, decreasing the pressure (expansion) of a gas can be accomplished by increasing the volume, decreasing the amount of gas, decreasing the temperature of the gas, and so on. Leaving volume constant, reducing the pressure within the liquid piston can cause the temperature of the gas to drop.

The flow 100 further includes warming 144 the working fluid in a gaseous state in the first liquid piston expander to enable substantially isothermal expansion. A variety of warming techniques can be used to warm the working fluid. In the flow 100, the warming is accomplished using a liquid spray 146. The liquid spray can include a liquid substantially similar to the piston liquid or can be dissimilar to the piston liquid. In embodiments, the liquid spray can include a liquid spray heated by heat stored in a thermal store. Recall that the working fluid can be compressed in order to accomplish exergy recovery techniques. Compressing the working fluid can cause the temperature of the working fluid to rise. The heat generated by compression can be captured and stored in the thermal store. In embodiments, the heat stored in the thermal store was generated by a process that produced the supply of working fluid. The stored heat can then be used to heat the liquid spray and for other warming and heating requirements associated with exergy recovery. Other sources of heat can be used. In embodiments, the warming can be accomplished using heat stored in structured packing associated with the first liquid piston expander. Further embodiments include warming the working fluid that was expanded to a third pressure in a second heat exchanger, wherein the second heat exchanger is fed by gas from the first liquid piston expander (discussed below). In embodiments, the second heat exchanger can use heat stored in a thermal store.

The flow 100 further includes expanding and heating 148 the working fluid at the second pressure before it enters the first liquid piston expander. The expanding and heating can be accomplished using an expander and a heat exchanger, an inter-heated expander, and so on.

The flow 100 includes splitting off 150 a portion of the working fluid expanded to a third pressure. In embodiments, the splitting off a portion of the working fluid expanded to a third pressure is used to source an auxiliary gas. The auxiliary gas can comprise one or more gases. In embodiments, the auxiliary gas can be the same composition as the working fluid. Other gases such as nitrogen, liquefied natural gas (LNG), and so on, can also be used. In other embodiments, the auxiliary gas can include cooled environmental air. The flow 100 further includes pressurizing the auxiliary gas 152. The auxiliary gas can be pressurized using one or more compressing stages, a biphasic pressurizer (BPP), and the like. In embodiments, the pressurizing the auxiliary gas can be performed by two or more liquid piston compressors working reciprocally. The two or more liquid piston compressors working reciprocally can enable the biphasic pressurizer. The flow 100 further includes precooling 154 the auxiliary gas that is mixed with the supply of working fluid while warming the auxiliary and working fluid mixture using a third heat exchanger. The precooling by the third heat exchanger can enable an auto-refrigeration loop, an exergetic loop, and so on. In the flow 100, the auxiliary gas is mixed 156 with the supply of working fluid. The mixing can be accomplished by injecting the auxiliary gas in a vessel containing the working fluid. In embodiments, the two or more liquid piston compressors can enable the mixing. In the flow 100, the auxiliary gas is dried 158 before it is mixed with the supply of liquefied air. The drying the auxiliary gas can remove vapor such as water vapor. The removing water vapor can reduce the first of building up rime or ice within one or more components of the working fluid exergy recovery system.

The flow 100 includes driving an engine 160 to recover work from the working fluid in a gaseous state. The engine can include a conventional turbine or reciprocating engine, a liquid piston, and so on. The engine can be used to recover work from the working fluid in a gaseous state and to use that work to convert energy to a different energy type. The different energy type can include electrical energy, mechanical energy, and so on. In embodiments, the engine is powered by liquid from the first liquid piston expander. The accessing, compressing, warming, expanding, and driving can be controlled using a computing device. The computing device can include a component within the energy management system. The computing device can include a central processing unit (CPU), a microcontroller, a processor, and so on. The computing device can include a processing core within a programmable device such as a field programmable gate array (FPGA). The computing device can include a processing core within an application specific integrated circuit (ASIC).

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

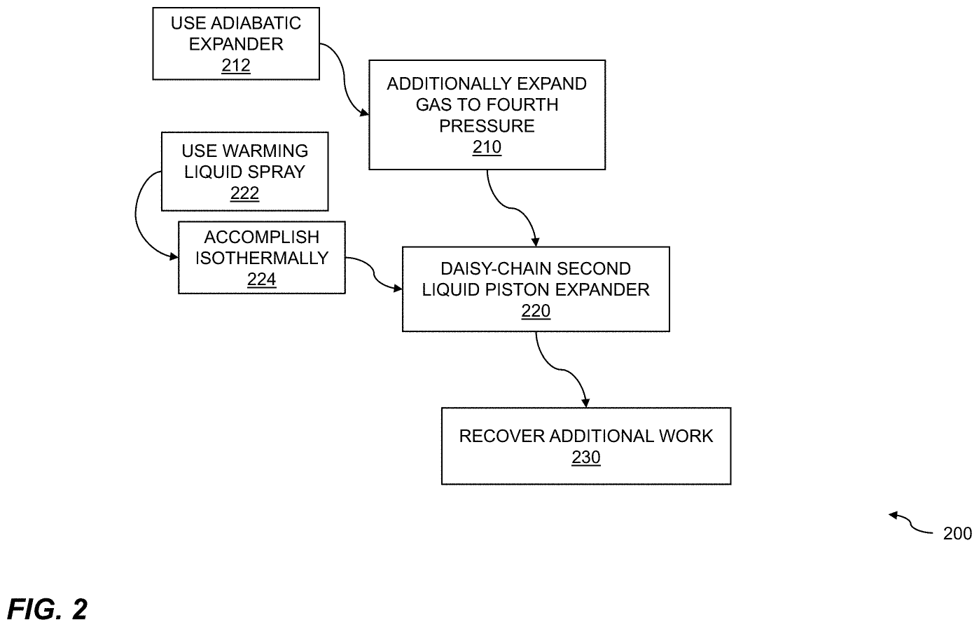

FIG. 2 is a flow diagram for driving an additional engine. The additional engine, which can include a liquid piston expander, an expander and inter-heater, a hybrid expander, and so on, can be used to recover additional work from a working fluid. The additional engine can be used to additionally expand a gas from a first liquid piston expander to a fourth pressure. The additionally expanding can be accomplished using an adiabatic expander. The fourth pressure to which the gas is expanded can be as low as atmospheric pressure. Driving the additional engine supports working fluid exergy recovery using hybrid processing. Hybrid processing can be accomplished using a one or more liquid piston expanders and an inter-heated expander. A supply of working fluid at a first pressure and a first temperature is accessed. The working fluid is compressed, wherein the compressing yields the working fluid at a second pressure, wherein the second pressure is greater than the first pressure. The working fluid at the second pressure to a second temperature is warmed using a first heat exchanger, wherein the second temperature is greater than the first temperature, wherein the working fluid at the second temperature is in a gaseous state. The working fluid in a gaseous state to a third pressure is expanded, wherein the expanding is accomplished using a first liquid piston expander. An engine is driven to recover work from the working fluid in a gaseous state, wherein the engine is powered by liquid from the first liquid piston expander.

The flow 200 includes additionally expanding a gas 210 from a first liquid piston expander that was heated by a second heat exchanger to a fourth pressure. The expanding can be accomplished using an expander such as an inter-heated expander, a liquid piston expander, and hybrid expander comprising a liquid piston expander and an inter-heated expander, and so on. The fourth pressure to which the gas is expanded can be slightly or substantially lower than the third pressure. In embodiments, the fourth pressure can be as low as atmospheric pressure. By expanding the gas to substantially one atmosphere, the gas can be released into the atmosphere, captured and stored for reuse, recycled, etc. In the flow 200, the additionally expanding the gas is accomplished using an adiabatic expander 212. The adiabatic expander can accomplish expanding the working fluid without transferring heat from the working fluid to the environment or transferring heat from the environment to the working fluid.

The flow 200 includes daisy-chaining 220 a second liquid piston expander between the first liquid piston expander and the second heat exchanger. The second liquid piston expander can include a high-pressure expander, a low-pressure expander, and so on. Additional liquid piston expanders can be daisy-chained between the first liquid piston expander and the second heat exchanger. The second liquid piston expander can be used to expand the gas and to recover work from the gas. The flow 200 further includes warming 222 the second liquid piston expander, where the warming can be accomplished using a liquid spray. The liquid spray can include a substance similar to that of the working fluid, a different substance, a combination of substances, etc. The liquid spray can include a heated liquid spray, where the heated liquid spray can be heated using heat stored in the thermal store. The warming can be further accomplished using heat stored in structured packing associated with the second liquid piston. In the flow 200, the heated liquid spray enables substantially isothermal expansion 224. The heated liquid spray can provide heat to the second liquid piston expander, where the provided heat can counteract cooling that can result from expanding the working fluid.

In the flow 200, the additionally expanding the gas from the first liquid piston expander that was heated by the second heat exchanger to a fourth pressure is used to recover additional work 230 from the supply of working fluid. The additional work can be used to convert stored energy to electrical energy, mechanical energy, and so on. In embodiments, the additional work can be recovered by driving an engine. The engine can include a pump, a pump-turbine, a liquid piston, and the like. The engine can be used to recover additional work from the working fluid in a gaseous state. The additional work can include converting energy stored in the working fluid to a different energy type. The different energy type can include electrical energy, mechanical energy, and so on. In embodiments, the engine is powered by liquid from the first liquid piston expander.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

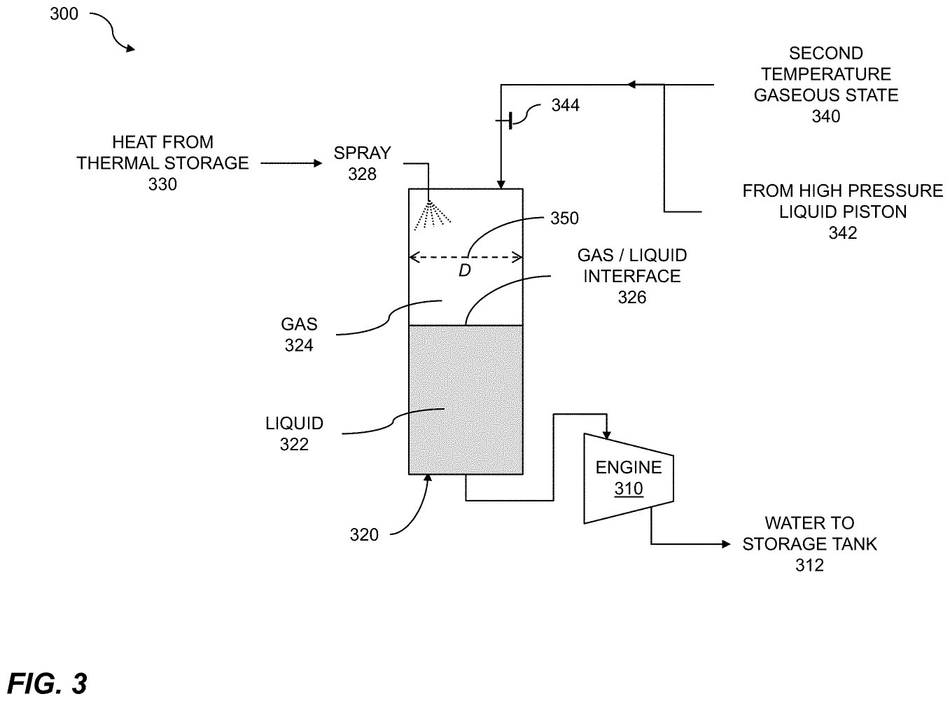

FIG. 3 is an infographic diagram of a liquid piston expander (LPE). A liquid piston expander can include a vessel such as a pressure vessel from which a gas or a liquid can be extracted. Various gases and liquids can be associated with the pressure vessel. In embodiments, the gas includes environmental air, and the liquid includes environmental water. The gas can be a working fluid that has been rendered to the gaseous or supercritical state, and the liquid can be a piston liquid, such as water, that is different from the working fluid. The working temperature of the LPE can be ambient temperature. Extracted liquid from the liquid piston can cause the gas within the liquid piston to expand. The extracted liquid can be used to recover work from the fluids in the pressure vessel. The liquid piston expander enables working fluid exergy recovery using hybrid processing. A supply of working fluid at a first pressure and a first temperature is accessed. The working fluid is pumped, wherein the pumping yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

An infographic diagram of a liquid piston expander is shown. The diagram 300 can include an engine 310. The engine can include a turbine, a pump-turbine, an engine operated by driving a liquid through the engine, and so on. The engine can be driven to recover work from the working fluid in a gaseous state. The engine can be powered by liquid such as liquid from a vessel, a pressure vessel, a tank, and so on. In embodiments, the liquid can include liquid from a liquid piston expander. The liquid used to drive the engine can be reused. In embodiments, the liquid comprises environmental water. Water that was used to drive the engine can be returned 312 to a storage tank for reuse.

The infographic diagram 300 can include a liquid piston expander 320. The liquid piston expander can include a vessel such as a pressure vessel. A liquid 322 and a gas 324 can be accessed from the liquid piston expander. In embodiments, the liquid that is accessed from the liquid piston expander can include environmental water, etc., and the gas that is accessed can include a working fluid such as liquefied air that has been pressurized and warmed to a gas at ambient or super-ambient temperature and environmental air. The liquid and the gas that are used within the liquid piston expander can be chosen to minimize mixing or absorption at a gas/liquid interface 326. The LPE can first be substantially filled up with piston liquid such as water at ambient pressure with the aid of a fill pump (not shown). Pressurized gas can then enter the vessel from the top, pushing the liquid out through the bottom using an engine 310. In embodiments, the pressurized gas can include a working fluid such as liquid air that has been pressurized and warmed to a temperature such that it is in the gaseous state 340. In other embodiments, the pressurized gas can include gas exhausted by another liquid piston at a higher pressure 342. Such pressurized gas can enter and fill the vessel at constant pressure (isobarically), forcing piston liquid 322 thru an engine 310 to perform work. Alternately or sequentially, a fixed amount of gas already in the vessel can expand to a lower pressure, forcing the piston liquid 322 out through the engine 310. As the pressure drops, the temperature of the gas can also drop. Reduction of the gas temperature is undesirable, since this also reduces the amount of work that can be extracted. If the temperature drops below the freezing point of the piston liquid (0° C. for water), issues related to freezing and blockage of flow conduits can occur. Further embodiments include warming the working fluid in a gaseous state in the first liquid piston expander to enable substantially isothermal expansion. The warming can be accomplished by a suitable packing within the vessel. The warming can be accomplished by injecting a substance into the liquid piston expander. In embodiments, the warming can be accomplished using a liquid spray 328. The liquid spray can be heated prior to application into the liquid piston expander. In embodiments, the liquid spray can include a liquid spray heated by heat 330 stored in a thermal store. The heat stored in the thermal store can include heat captured from liquefaction of a gas. The heat that is captured can include heat resulting from compression of a gas.

The liquid piston expander 320 can have an inner diameter 350. The inner diameter, nomenclated as D, can play an important role in determining the how fast thermal energy can be transferred through the side walls of the liquid piston expander. A small diameter, narrow liquid piston expander can heat or cool its contents faster through side wall conduction than a large diameter expander can. Of course, the smaller the diameter, the smaller the volume, at a given liquid piston expander height. Thus an alternative liquid piston expander warming technique is disclosed. In embodiments, the warming is accomplished by a plurality of liquid piston expanders operating in parallel, using expander wall conduction heat transfer. In some embodiments, the plurality of liquid piston expanders each has an inner diameter of less than two inches. In other embodiments, the plurality of liquid piston expanders each has an inner diameter of less than one inch. In embodiments, the warming is accomplished using heat stored in structured packing associated with the plurality of liquid piston expanders. Other heat storage and heat transfer media are possible, such as using a warming liquid that envelops all or part of the plurality of liquid piston expanders, using impingement warming with a warm gas stream, and so on. In order to maintain the total volume of working fluid expansion required, the plurality can comprise hundreds or even thousands of small diameter liquid piston expanders working in parallel. Of course, the disclosed concepts also apply to cooling the contents of liquid piston compressors.

In embodiments, the warming can include warming a working fluid at a second pressure to a second temperature using a first heat exchanger. Heat, such as heat stored in the thermal store, can be applied to the heat exchanger to warm the working fluid. In embodiments, the second temperature can be greater than the first temperature. The difference between the first temperature and the second temperature can range from a few degrees to many degrees. In embodiments, the working fluid at the second temperature can be in a gaseous state 340 and can be provided to the liquid piston expander. Another source of heat can include a second liquid piston. In embodiments, the second piston can include a high pressure liquid piston. A heated gas from the high pressure liquid piston 342 can also be provided to the liquid piston expander. The working fluid at the second temperature 340 and the working fluid from the high pressure liquid piston 342 can be provided to the liquid piston expander 320 via a control valve 344.

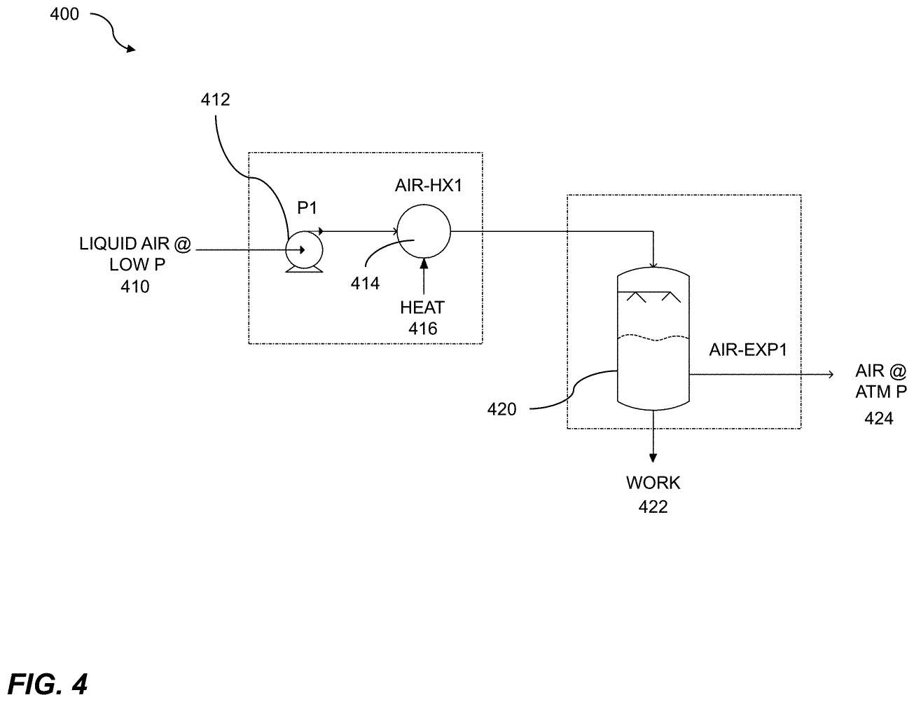

FIG. 4 illustrates liquid piston-based (LP-based) work extraction with a liquid piston expander. A liquid piston comprises a vessel such as a high-pressure vessel that can include a liquid, a gas, or a liquid and a gas. When both liquid and gas are present within the liquid piston, the liquid is in contact with the gas. By pumping in or removing liquid or gas from the liquid piston, the pressure within the liquid piston can be modified. The liquid piston can be used to extract work from the working fluid. Extracting work from the liquid piston enables working fluid exergy recovery using hybrid processing. A supply of working fluid at a first pressure and a first temperature is accessed. The working fluid is pumped, wherein the pumping yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

Described throughout, exergy is the capacity of a given mass of a substance to perform mechanical or electrical work as it equilibrates with the ambient surroundings. The more different its physical state is relative to the ambient environment, as measured by pressure, temperature, elevation, voltage, etc., the greater its exergy. Thus, a vessel of gas at high pressure has exergy since it can drive an engine while being discarded into ambient surroundings at 1 atmosphere. The higher the vessel pressure, the higher the exergy; if the vessel pressure is only 1 atmosphere, it has zero exergy. Liquid air is very cold—below −140.5° C. It is also dense. Thus, it can store a substantial amount of exergy. As it warms up, it loses exergy. Liquid air can be pressurized with a pump using a relatively modest amount of work, since it is relatively much less compressible than a gas. Pressurized liquid air has a large exergy. As it gets warmed up to ambient temperature isobarically, it has to shed this exergy. It is desirable to recover this shed exergy in the form of useful work, otherwise the exergy is shed as “lost work”. Once warmed to ambient temperature, the pressurized liquid air has become a supercritical fluid, often referred to as a gas. Since it is still at pressure, this ambient temperature fluid still has substantial exergy. Exergy can be recovered in the form of useful work by employing a combination of liquid piston expanders and conventional machinery, such as turbines and engines. In addition to exergy recovery from pressurized fluid at ambient temperature, additional exergy is recovered during the warming of the liquid air from cryogenic to ambient temperatures using exergetic loops. An exergetic fluid different from the working fluid or air can be used in a closed, self-contained loop, which is isolated from the working fluid, but in thermal contact. A biphasic pressurizer can be useful for implementing the auto-exergetic loops.

In addition to exergy stored in liquid air, exergy can also be stored in thermal stores. For example, a portion of the compression work that was expended to liquefy air in the first place, can have been stored. Such a thermal store can be any medium that retains the heat of compression, and it could be in the form of a packed bed of ceramics, a tank of hot water, etc. Exergy can be recovered from these thermal stores alongside, and in addition to, that recovered from liquid air.

Work extraction using a liquid piston is shown 400. Exergy can be stored in liquefied air, such as liquid air 410. Exergy extraction from liquefied air into mechanical work is illustrated in 400. The liquefied air can be pressurized to a high pressure using a pump P1 412. The pumping the liquefied air can cause the temperature of the liquefied air to rise a few degrees. Even so, the temperature of the so pressurized air can still be sub-ambient. Since liquid air is not as compressible as gaseous gas, relatively little work is expended in pressurizing it. The liquefied air can be further warmed to a temperature, such as ambient temperature, a temperature higher than ambient, and so on, using an air heat exchanger AIR-HX1 414 in air heat exchange domain, supplied by heat 416. The heat 416 can be provided from ambient surroundings, which furnishes an abundant supply of heat up to ambient temperature. Additionally, heat can also be sourced from a thermal store, which can heat up the stream to above ambient temperatures. If such a heat store is used, preferably it is used in conjunction with the ambient heat source, in a sequence in which the stream is first heated to ambient temperature by the ambient surroundings only, followed by heating with the heat store. It may be desirable to split up the heat exchange domain into multiple physical devices such as heat exchanger AIR-HX1 414 and heat store devices such as packed beds (not shown). In other embodiments, the heat stored in the thermal store can have been generated by a process that produced the supply of working fluid. Warming the pressurized, liquefied air to ambient or super-ambient temperatures renders it into a pressurized, supercritical fluid. This supercritical fluid can be expanded in an expander engine. In embodiments, the expander engine can include a liquid piston expander 420. Expansion of a gas can cause the temperature of the gas to drop, possibly significantly. The temperature of expanding gas in the liquid piston expander can be controlled by providing heat to the expanding gas. For example, the temperature of the expanding gas can be substantially isothermal. Further embodiments can include warming the expanding gas to keep it isothermal by using a liquid spray or a packing inside the pressure vessel. Work 422 can be extracted from the liquid piston expander. The work can include spinning a turbine, operating a pump-turbine etc. By extracting work, the pressure in the vessel can be reduced. In embodiments, the pressure reduces to atmospheric pressure, at which pressure the air, 424, can be discharged. The air can be discharged via a vent at the top of the vessel by filling up the vessel with water. The vessel is then ready to receive the next charge of supercritical air from the heat exchange zone 416. By alternately filling, and depressurizing the vessel in a cyclic process, work is generated intermittently. By using two such vessels, operating in identical cycles but half-a-cycle out of phase with each other, work can be generated continuously.

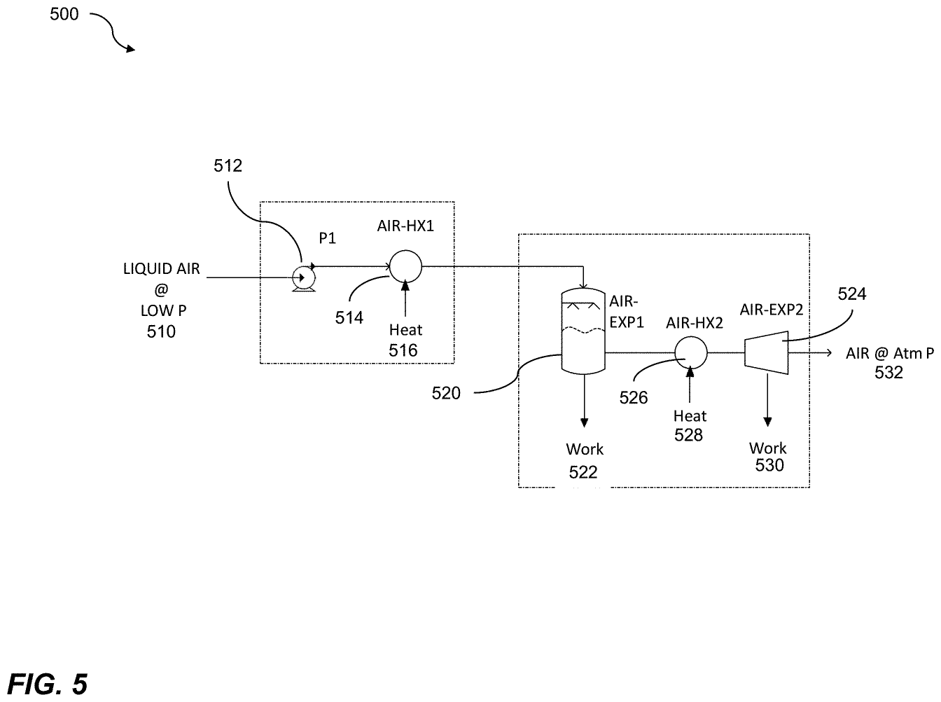

FIG. 5 shows hybrid expansion. Hybrid expansion can be accomplished using a liquid piston expander at high pressure, and a multistage inter-heated expander at low pressure. Discussed previously, a liquid piston comprises a vessel such as a high-pressure vessel that can include a liquid, a gas, or a liquid and a gas. The boundary or interface between a liquid and a gas within the high-pressure vessel forms the liquid piston. The pressure within the liquid piston can be increased (compression) or decreased (expansion) by providing or accessing liquid or gas within the liquid piston. The liquid piston and the inter-heated expander can be used to extract work from the working fluid. Extracting work from the liquid piston and the inter-heated expander enables working fluid exergy recovery using hybrid processing. A supply of working fluid at a first pressure and a first temperature is accessed. The working fluid is pumped, wherein the pumping yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

Hybrid expansion based on using a liquid piston and an inter-heated expander is shown 500 to recover the exergy stored in a working fluid such as liquid air at low pressure 510. The liquid air (liquefied air) can be pressurized to a high pressure using a pump P1 512, a pump-turbine, and so on. In the example shown, the liquefied air can be warmed to a temperature, such as ambient temperature or higher, using an air heat exchanger AIR-HX1 514. Heat 516 provided to the air heat exchanger can be obtained from a heat source such as ambient surroundings or a thermal store. As discussed previously, ambient heat can be used to warm the air up to near-ambient temperatures, and, optionally, the thermal store can be used to warm it further. The compressed and warmed liquefied air, now in a supercritical pressurized gaseous state, can be expanded in an expander engine such as a liquid piston expander 520. The expansion of gas inside the liquid piston expander can be made substantially isothermal by providing a liquid spray into the liquid piston expander. Work 522 can be extracted from the liquid piston expander. The work can include spinning a turbine, operating a pump-turbine etc. The gas from the liquid piston expander 520 can be further expanded using an expander 524. Expander 524 can be any conventional machine, including a turbine or positive displacement engine. The machines can be substantially adiabatic, in which case the extraction of work 530 from the machine will cause the gas to cool off. This can be undesirable, as it can progressively decrease the amount of work 530 that can be extracted. Further, it can also cause the gas to cool off below the desublimation point of the vapors of the piston liquid, which can cause operational problems. It may be desirable to preheat the fluid feeding the expander 524 to a temperature above ambient, such that the exhaust of the expander does not drop below the freezing point, or preferably, ambient temperature. To this end, the additionally expanding gas from the liquid piston expander 520 can be heated by a second heat exchanger AIR-HX2 526 to a temperature higher than ambient. Heat 528 can be provided to the second heat exchanger from a store such as the thermal store. The additional expansion of the inter-heated expander can recover additional work 530 from the supply of working fluid. By using the liquid piston expander and the inter-heated expander to recover work and additional work, the gas pressure can be reduced. In embodiments, the pressure is reduced to atmospheric pressure, and the air can be discharged to ambient surroundings 532.

The volume of the liquid piston expander 520 and the flowrate of the piston liquid are inversely proportional to the final exhaust pressure of the gas exiting the vessel. By utilizing the LPE only at relatively high pressures, this volume and flowrate are kept relatively small. In addition, a large reduction in pressure is possible in a single stage of the LPE while still keeping the expanding gas isothermal, with the employment of sprays or packings.

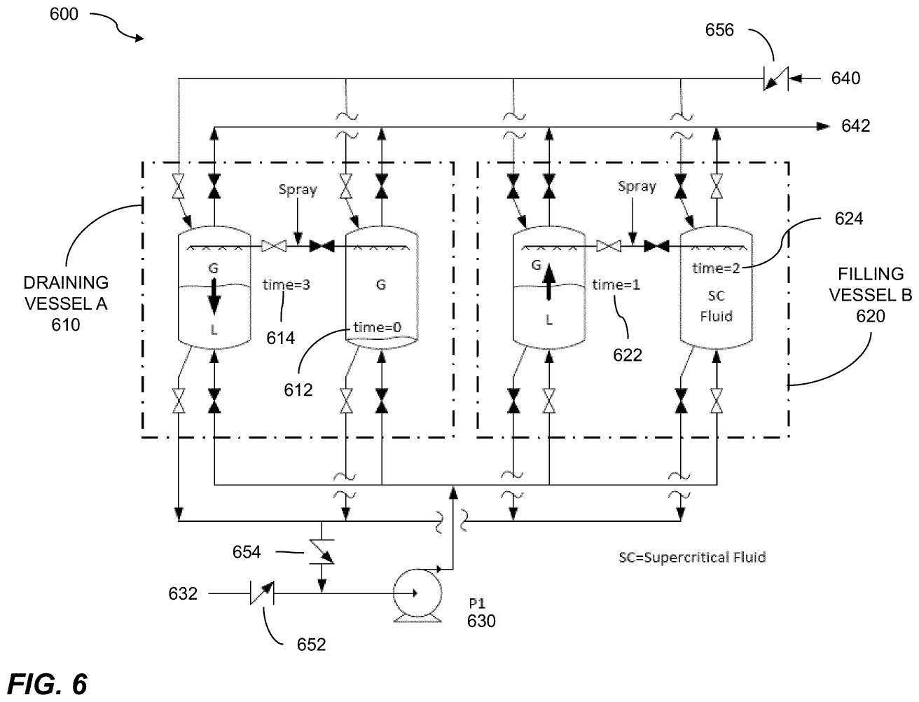

FIG. 6 illustrates a block diagram for a biphasic pressurizer. A biphasic pressurizer can include two vessels, where the vessels can include pressure vessels. The vessels can be operated cyclically, but a half-cycle out of phase, in order that working fluid such as liquefied air can be provided at high pressure, substantially continuously. The biphasic pressurizer enables working fluid exergy recovery using hybrid processing. A supply of working fluid at a first pressure and a first temperature is accessed. The gas is compressed. The compressing yields the working fluid at a second pressure which is greater than the first pressure. The working fluid at the second pressure is warmed to a second temperature using a first heat exchanger. The second temperature is greater than the first temperature, and the working fluid at the second temperature is in a gaseous state. The working fluid in a gaseous state is expanded to a third pressure. The expanding is accomplished using a first liquid piston expander. An engine is driven to recover work from the working fluid in a gaseous state. The engine is powered by liquid from the first liquid piston expander.

A block diagram 600 is shown for a biphasic pressurizer (BPP). The biphasic pressurizer comprises two vessels, vessel A 610, and vessel B 620. Note that in the diagram 600, vessels A and B are illustrated at different points in time. The points in time can include time T0 612, time T1 622, time T2 624, and time T3 614. The different points in time can refer to filling a vessel, draining a vessel, pressurizing a vessel, and so on. By phasing the operations of the vessels, a liquid such as a working fluid can be provided nearly continuously and at high pressure. Each vessel can be coupled to switching valves. In the example shown, each vessel is coupled to four switching valves. The switching valves can be switched on (black), or switched off (white). The valves can couple the vessels to a pressurizing pump, to recycled gas, and so on. The valves can further be coupled to provide working fluid at high pressure, to recycle gas and working fluid, and so on. In the block diagram a first switching valve 652 for liquid input can couple a vessel to a pump P1 630. The pump P1 can access a supply of liquefied air at low pressure 632, and can provide working fluid at high pressure to a vessel. A second switching valve 654 can include a low pressure drain valve. The drain valve can drain liquid, condensate, precipitate, and so on, from a vessel. Liquid drained through a drain valve can be recycled by providing the liquid back to the pump P1. A third valve 656 can include an inlet valve. The third valve can be used to provide recycled, cooled vapor 640 resulting from hybrid processing for exergy recovery. A fourth valve (not shown) can include an outlet valve. The fourth valve can provide liquefied air at high pressure 642. The liquefied air at high pressure 642 can be provided substantially continuously when vessels A and B are operated synchronously and 180° out of phase. The liquefied air at high pressure can be provided to an air heat exchanger in part for working fluid exergy recovery. In embodiments, the switching valves can be operated by a controller (not shown) such as a programmable logic controller (PLC).

A usage example follows: Consider vessel B 620 to be substantially full of low-pressure vaporous air at a time T0. Pump P1 630 can pump liquid air into vessel B at the bottom of the vessel through a switching valve. A portion of the liquid can be sourced from a liquid-air storage tank. Another portion of the liquid air can be sourced from the draining of another vessel such as vessel A 610. Valves associated with vessel B, except for a vessel bottom inlet valve, can be closed during a period of time T1. Vessel B can be filled with liquid from the bottom of the vessel. While vessel B fills, vaporous air within a headspace of vessel B gets progressively compressed during T1. Recall that pressurizing a gas such as air vapor can cause the temperature of the air vapor to increase. In embodiments, a portion of liquid air can be sprayed into vessel B. Continuing to increase pressure within vessel B can cause the pressure within the vessel to reach a critical pressure at which there are no longer two distinct phases (liquid, gas) of the substance within the vessel. At the critical pressure, the vessel can contain a supercritical fluid or liquid. At time T2, vessel B can be pressurized above the critical pressure of air, resulting in a single phase filling vessel B at a target pressure. An outlet switching valve at the top of vessel B can be opened, and pump P1 can continue to operate. The supercritical liquid within vessel B can be provided at a substantially constant high pressure. The providing can include a target amount of the supercritical liquid.

When a target amount of the supercritical liquid has been delivered, a liquid inlet valve at the bottom of vessel B and a liquid outlet valve at the top of vessel B can be closed. The valves can be closed at a time such as time T2. A liquid drain valve associated with vessel B can be opened, and the supercritical liquid at high pressure within vessel B can depressurize toward a lower pressure. Further, the depressurized liquid within vessel B can be provided to the pump P1. When the pressure within vessel B drops below the critical pressure, the substance within vessel B can return to two phases. The liquid phase of the substance can progressively flash into a vapor within headspace of vessel B. The vapor headspace can expand, substantially isentropically, causing the liquid within vessel B to exit the vessel through the drain valve at the bottom and into the pump P1. Pump P1 can initiate pressurizing vessel A as described above for vessel B. The pressure in vessel B can fall quickly to a pressure that can be lower than a pressure associated with a low-pressure recycle gas 640. A switched gas inlet valve at the top of vessel B can be opened to provide additional recycle gas into vessel B. The recycled gas can continue to fill vessel B from the top of the vessel, while low-pressure liquid can continue to drain from the bottom of vessel B1. The draining low-pressure liquid can be provided to the pump P1, which then aids in aspirating the low-pressure recycle gas into the vessel B. When the liquid level within vessel B reaches a threshold, minimum, or preset level within vessel B, the drain valve can be closed, and the top gas fill valve can be closed. The filling and draining cycle can repeat. Vessel B can be substantially filled with a next amount of recycled gas, pressurized, drained, and so on.

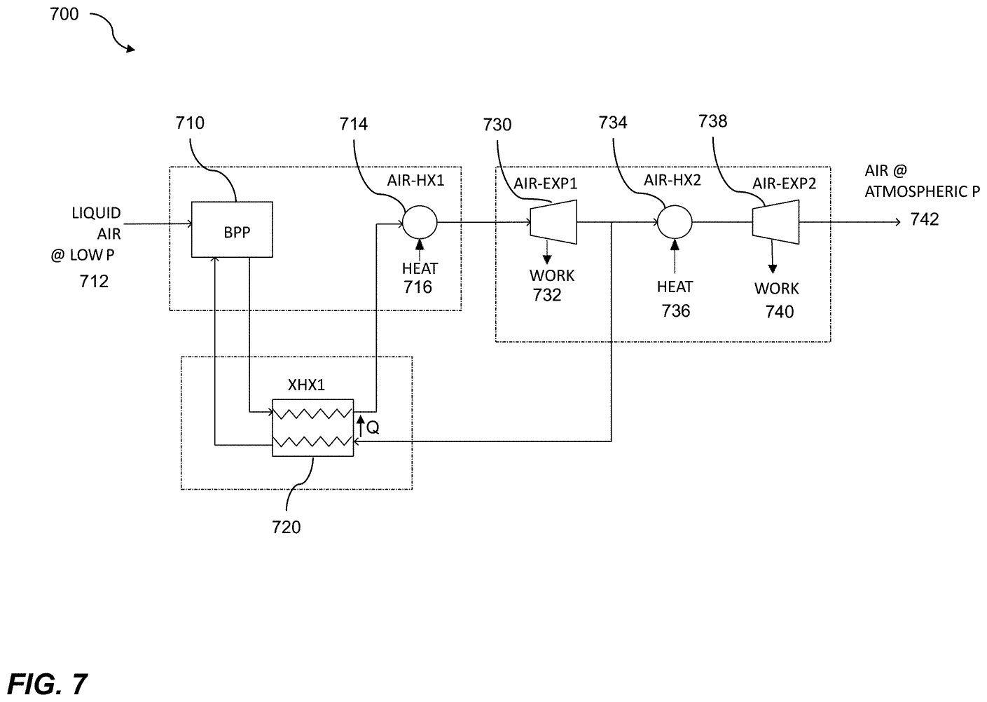

FIG. 7 shows exergy recovery from liquefied air. Discussed throughout, the temperature of a gas rises when the gas is compressed and falls when the gas is expanded. The heat generated by compression can be captured and stored in a thermal store. The stored heat can be used to heat a gas or a liquid used for additional exergy recovery. A portion of a substance in gaseous form that is cooled by expansion can be used to provide cooling to the substance in a gaseous or liquid form. In embodiments, a portion of a substance in gaseous form that is expanded in part for exergy recovery can be used to warm the substance in another portion for additional exergy recovery. Gas such as auxiliary gas can enhance working fluid exergy recovery using hybrid processing. A supply of working fluid at a first pressure and a first temperature is accessed. The working fluid is compressed, and the working fluid is warmed to a second temperature. The working fluid in a gaseous state is expanded using a liquid piston expander. An engine is driven to recover work from the working fluid in a gaseous state.

Enhanced exergy recovery by the recycling of near-ambient temperature air is shown in 700. A biphasic pressurizer (BPP) 710 can comprise two vessels such as pressure vessels and can be used to pressurize a gas by pumping up a liquid to form a supercritical fluid. The BPP can access a working fluid such a liquid air at low pressure 712, and a recycled slipstream of expanded gas at low pressure (discussed below) to combine and pressurize them into a single stream of supercritical fluid. The combined supercritical stream can be warmed in a heat exchanger 720, where heat can be transferred to the combined supercritical stream from the BPP, from the recycling slipstream of warmer gas from an expander (discussed below). The combined supercritical stream from the BPP that is directed through the heat exchanger 720 can be directed to a first air heat exchanger AIR-HX1 in air heat exchange domain 714. Heat 716 can be provided to the air heat exchange domain. The heat can be sourced from the ambient surroundings, which form a vast supply of heat, but which is limited to ambient temperature. Additionally, heat can also be sourced from a heat store, which can heat up the stream to above ambient temperatures. If such a heat store is used, preferably it is used in conjunction with the ambient heat source, in a sequence in which the stream is first heated to ambient temperature by the ambient surroundings only, followed by heating with the heat store. It may be desirable to split up heat exchange domain 714 into multiple physical devices such as heat exchanger AIR-HX1, and heat store devices such as packed beds. The output of the air heat exchanger can be provided to an expander AIR-EXP1 730. AIR-EXP1 can be any commercially available engine that is driven by a source of compressed gas. It can be an axial or other turbine. It can be a reciprocating engine. It can be of the positive displacement type. The engine can be coupled to a load, including an electrical load such as a generator, to recover mechanical or electrical work. In embodiments, the expanding can be accomplished using a first liquid piston expander. Work 732 can be recovered from the working fluid in gaseous state by driving an engine. In embodiments, the engine can be powered by liquid from the expander such as a first liquid piston expander. In further embodiments, the gas from the expander 730 can be heated by a second heat exchanger AIR-HX2 734, or inter-heater. Heat 736 can be provided to the second heat exchanger from a store such as a thermal store. The heated gas such as air from the air heat exchanger 734 can be provided to a second expander AIR-EXP2 738. Like AIR-EXP1 730, AIR-EXP2 738 can be any conventional expander such as a turbine or a reciprocating engine. The additional expansion of the inter-heated expander can recover additional work 740 from the supply of working fluid. By using the first expander, AIR-EXP1 730 and the inter-heated expander, AIR-EXP2 738 to extract work and additional work, the liquefied air can be returned to a gaseous state. In embodiments, the air in gaseous state includes air at atmospheric pressure 742.

A portion of the gas exiting the first expander, AIR-EXP1 730, can be extracted as a slipstream to seed the auto-exergetic recycle loop. This portion can be in the range of 1-40%. The slipstream can be at ambient temperature. It can be warmer combined supercritical fluid from the BPP. It can be directed to heat exchanger XHX1, where it can be cooled by heat exchange with the warming combined supercritical fluid from the BPP. Recall that at sub-ambient temperatures, a given mass of warming fluid loses exergy, while a cooling fluid gains exergy; the exergy flow direction is opposite that of the heat flow direction, Q, in XHX1 720. This way, the exergy shed by the combined supercritical fluid even as it warms up toward ambient temperature is not discarded, but is substantially recaptured in the recycled slipstream. The mass of the combined supercritical stream is higher than the mass of the fresh liquid air feed alone. The additional mass of the combined stream flowing through the expanders AIR-EXP1 and AIR-EXP2 increases the work recovered by those engines.

The recycled slipstream is generally a gas at low pressure. The streams can be pressurized separately and independently, and then they can be combined. Thus, a pump can be used to pressurize the liquid air. A compressor can be used for the recycled slipstream. The recycled slipstream, being a gas, is quite compressible, and tends to heat up upon compression. The gas can be progressively cooled with a small, measured portion of liquid air, such as by spraying in direct contact, or in a heat exchanger by indirect contact. In either case, this would boil that portion of coolant liquid air, and the vapor so generated can be combined with the recycled slipstream being compressed in an increasing vapor mass and pressure process that minimizes the overall compression work. Such a process may be implemented in multiple pressure stages, for example, three stages. Alternately, the biphasic pressurizer described earlier can be used, which offers a convenient way to pressurize a combination of a liquid and a gas stream.

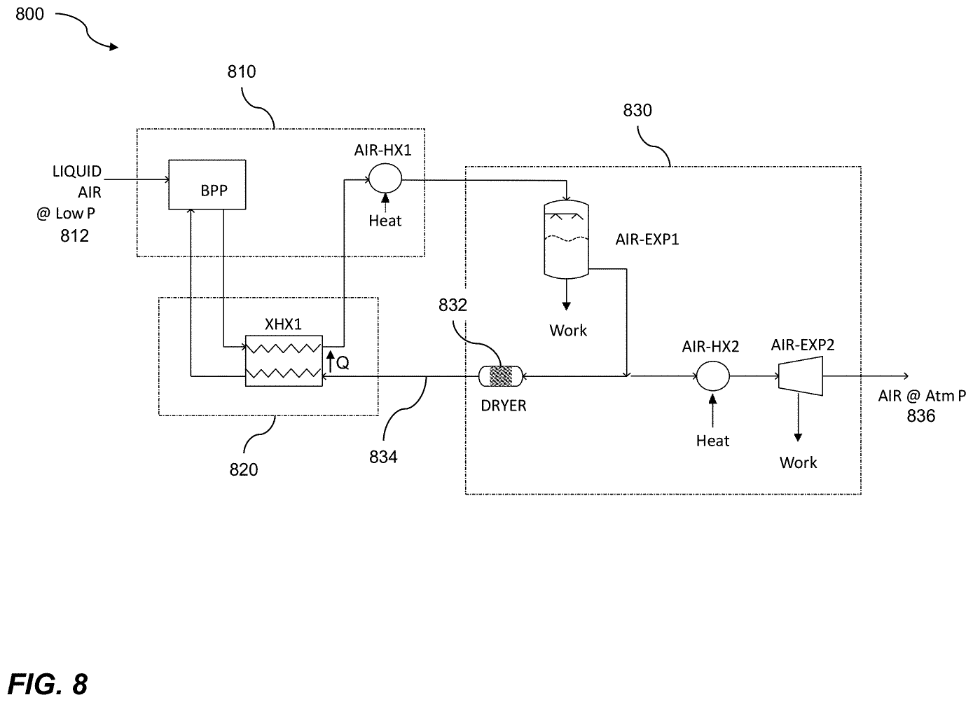

FIG. 8 illustrates enhancement of exergy recovery from liquefied air using a liquid piston and dryer. Recycle of the slipstream of near-ambient temperature partially expanded air as discussed above can further include a dryer to remove vapor from the gas. The dryer can be used to dry or dehydrate a gas such as air. By removing vapor from the gas, the risk of the development of rime or ice when cooling the gas can be significantly reduced. Discussed previously, a portion of a substance in gaseous form that has been expanded can be used to cool the substance in another portion of a system for exergy recovery. Such cooling of a substance by the substance can be accomplished using one or more auto-exergetic loops. A recycled slipstream of gas can enhance working fluid exergy recovery using hybrid processing. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

Enhanced exergy recovery by the recycle of near-ambient temperature partially expanded air with a dryer is shown 800. A biphasic pressurizer (BPP) and air heat exchanger block 810 can access liquid air at low pressure 812. The liquid air can be stored in a tank, a vessel such as a pressure vessel, and so on. The output of the BPP can be provided to a heat exchanger 820 prior to being directed to an air heat exchanger AIR-HX1. The output of the air heat exchanger can be directed to a hybrid expander block 830. The hybrid expander block can include a liquid piston expander, an inter-heater, and an expander. In addition to liquid piston expander, inter-heater, and expander components associated with the hybrid expander, the hybrid expander can further include a dryer 832. A portion of the partially expanded gas output of the liquid piston expander can be directed to the dryer. The dryer can remove vapor such as water vapor prior to providing the dried gas 834 to the heat exchanger 820. The drying of the gas can prevent formation and buildup of rime, ice, etc. within a heat exchanger, the BPP, and so on. As discussed above, the expansion by the liquid piston expander and the additional expansion of the inter-heated expander can recover work and additional work from a supply of working fluid. Using the liquid piston expander and the inter-heated expander can return the liquefied air to a gaseous state. In embodiments, the air in a gaseous state includes air at atmospheric pressure 836.

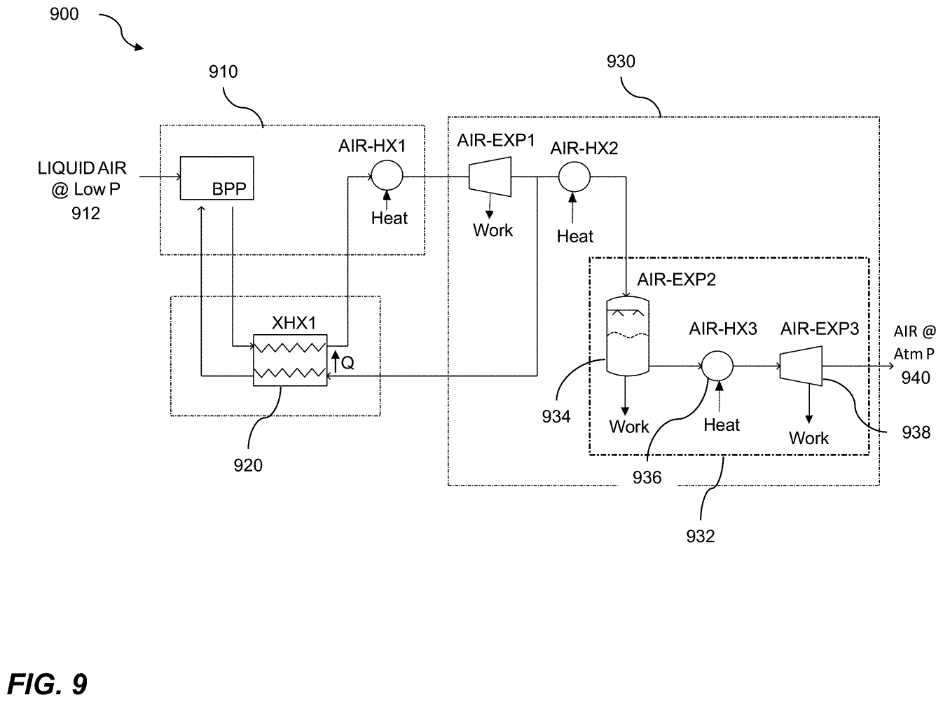

FIG. 9 shows enhanced exergy recovery with hybrid expansion. Continuing the discussion of auto-exergetic loops, an associated expander can be augmented using hybrid expansion. Discussed above, hybrid expansion can be accomplished using a liquid piston expander at a pressure such as high pressure, and a multistage inter-heated expander at a second pressure such as a low pressure. A liquid piston comprises a vessel such as a high-pressure vessel that can include a liquid, a gas, a liquid and a gas, a supercritical fluid, etc. The boundary or interface between a liquid and a gas within the high-pressure vessel forms the liquid piston. The pressure within the liquid piston can be increased (compression) or decreased (expansion) by providing or accessing liquid or gas within the liquid piston. The liquid piston and the inter-heated expander can be used to extract work from the working fluid. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

Enhanced exergy recovery by the recycle of near-ambient temperature air with hybrid expansion is shown 900. The operations of blocks 910 and 920 have been discussed in detail previously and will be summarized here. A biphasic pressurizer (BPP) and air heat exchanger block 910 can access liquid air at low pressure 912. The liquid air can be stored in a tank, a cryogenic tank, a pressure vessel, and the like. The output of the BPP can be provided to a heat exchanger 920 prior to being directed to an air heat exchanger AIR-HX1. The output of the air heat exchanger AIR-HX1 can be directed to an expander block 930. The hybrid expander block 930 can include an expander such as AIR-EXP1 and an air heat exchanger AIR-HX2. Work can be recovered from the expander AIR-EXP1. A portion of the gaseous output of the expander can be directed to the heat exchanger XHX1 920. Heat can be transferred from the portion of the output of the expander AIR-EXP1 to the output of the BPP. The second air-heat exchanger AIR-HX2 can be coupled to a hybrid expander 932. The hybrid expander can comprise a liquid piston expander 934, an inter-heater 936, and an expander 938. Discussed above, the expansion by the air expander AIR-EXP1, the liquid piston expander, and the additional expansion of the inter-heated expander can recover work and additional work from a supply of working fluid. The output of the air expander 938 can comprise a fourth pressure, where the fourth pressure can be substantially one atmosphere 940. The air at a pressure of substantially one atmosphere can be released to the atmosphere, captured for reuse, etc.

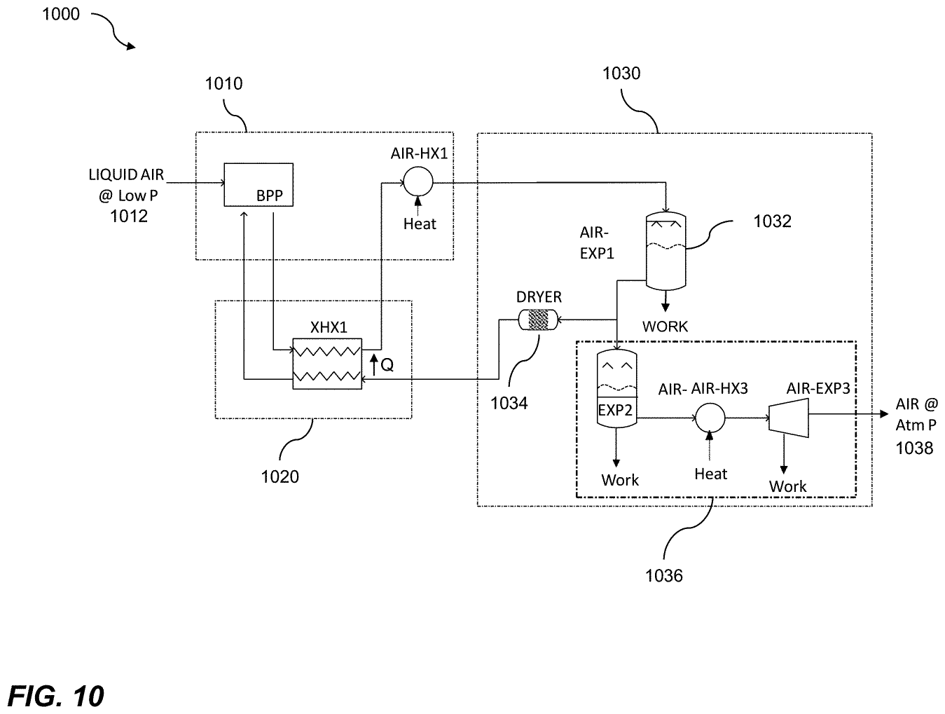

FIG. 10 illustrates hybrid multistage liquid piston expansion. Continuing the discussion of enhancement of exergy recovery in an auto-exergetic recycle loop, a first liquid piston expander 1032 is associated with an auto-exergetic loop. The first liquid piston expander can replace an air expander and air heat exchanger of previous examples. The first liquid piston expander can be coupled to a hybrid expander. Multistage hybrid expansion can be accomplished using two or more liquid piston expanders, where one liquid piston expander can operate at a first pressure, and the second liquid piston expander can operate at a second pressure. Discussed previously and throughout, a liquid piston comprises a vessel that can include a liquid, a gas, a liquid and a gas, a supercritical fluid, and so on. The liquid and the gas can be chosen to minimize mixing or absorption of the gas and the liquid. The boundary or interface between a liquid and a gas within a high-pressure vessel forms the liquid piston. The pressure within the liquid piston can be increased or decreased by providing or accessing liquid or gas within the liquid piston, respectively. The first liquid piston expander and the hybrid expander comprising the second liquid piston and an inter-heated expander can be used to extract work from the working fluid. Hybrid multistate liquid piston expansion enables working fluid exergy recovery using hybrid processing. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

An example configuration of hybrid multistage liquid piston expansion is shown 1000. The descriptions of blocks 1010 and 1020 are summarized here. A biphasic pressurizer (BPP) and air heat exchanger block 1010 can access liquid air. The liquid air can be at a low pressure 1012. The liquid air can be stored in a tank, a cryogenic tank, a pressure vessel, etc. The output of the BPP can be provided to a heat exchanger XHX1 1020 prior to being directed to an air heat exchanger AIR-HX1. The output of the air heat exchanger can be provided to a hybrid multistage expander block 1030. The hybrid expander block can include a first liquid piston expander such as AIR-EXP1 1032. Note that the second air heat exchanger previously discussed is absent. Instead, heat can be provided to the liquid piston expander 1032 to accomplish warming of the contents of the liquid piston expander. In embodiments, the warming can be accomplished using a liquid spray. Work can be recovered from the liquid piston expander 1032. A portion of the gaseous output of the liquid piston expander can be directed through a dryer 1034 to the heat exchanger 1020. The dryer can remove vapor such as water vapor from liquefied air, air, etc. Heat can be transferred from the dried portion of the output of the liquid piston expander 1032 to the output of the BPP. The remaining gaseous output of the first liquid piston expander can be provided to a hybrid expander 1036. The hybrid expander can comprise a second liquid piston expander, an inter-heater, and an expander. The second liquid piston expander can be daisy-chained between the first liquid piston expander and the second air heat exchanger (e.g., the inter-heater). Further embodiments include warming the second liquid piston expander to enable substantially isothermal expansion by using a liquid spray. As discussed previously, the expansion by the first liquid piston expander 1032, the second liquid piston expander, and the additional expansion of the inter-heated expander, can recover work and additional work from a supply of working fluid. The output of the air expander can comprise a fourth pressure, where the fourth pressure can be substantially one atmosphere 1038. The air at a pressure of substantially one atmosphere can be released to the atmosphere, captured for reuse, stored, and so on.

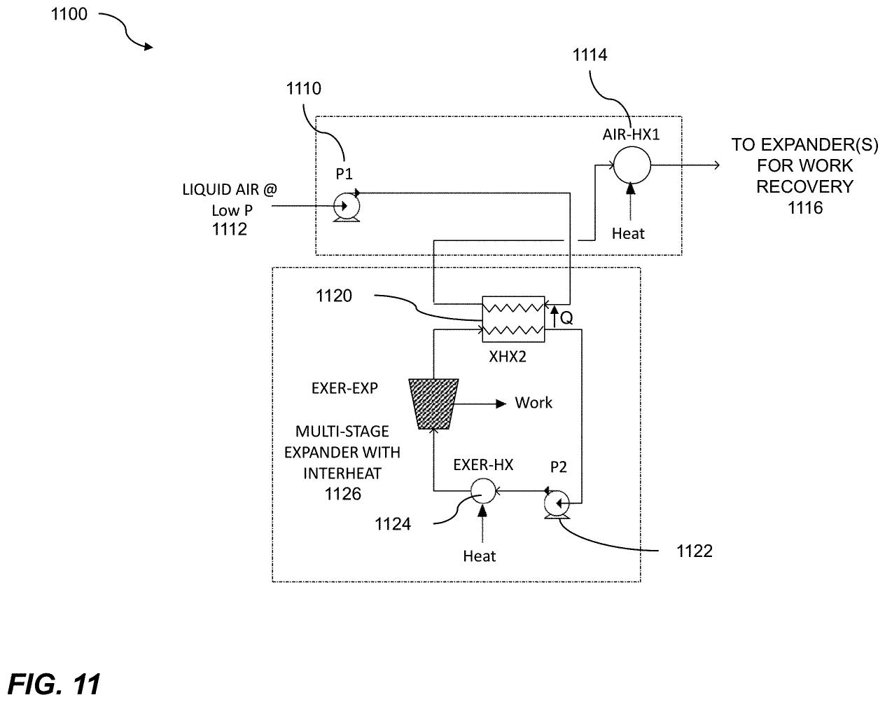

FIG. 11 shows a multistage exergetic loop. Enhanced exergy recovery with a self-contained exergetic loop is shown 1100. Recall that the exergy of a system can be defined by a maximum amount of work that can be provided by a system as the system equilibrates with a heat reservoir, an environment that surrounds the system, and so on. The exergetic loop can be used extract exergy from a warming sub-ambient gas, in this instance a compressed working fluid. The exergetic loop enables working fluid exergy recovery using hybrid processing. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

Enhanced exergy recovery with a self-contained exergetic loop is shown in 1100. A pump P1 1110 can be used to pressurize or compress a working fluid such as liquid air at a low pressure 1112. In embodiments, the compressing the liquefied air can yield the working fluid at a second pressure, where the second pressure is greater than the first pressure of the liquefied air. The compressed liquefied air can be provided to a heat exchanger 1120. The heat exchanger can transfer heat from, and exergy to, an exergetic loop (described below). The output of the heat exchanger can be provided to an air heat exchanger 1114. The output of the air heat exchanger can be provided to one or more expanders 1116, such as conventional multistage expanders, with inter-heating, liquid piston expanders, hybrid expanders, and so on, discussed previously and throughout. The exergetic loop can comprise a fluid different from the liquefied air. Various fluids, so-called exergetic fluids such as refrigerants R23 (trifluoroethane), R134A, and R245FA, ethane, propane, butane, pentane, and so on, can be used for the exergetic loop. The exergetic loop can include a pump P2 1122 which can be used to compress the exergetic fluid, a heat exchanger 1124, and a multi-stage expander with inter-heating 1126. The multi-stage expander with inter-heating can be used to recover work, thereby enhancing the exergy recovery from the warming compressed liquefied air from pump P1 using heat exchanger 1120.

A usage example follows: The exergetic fluid, in liquidous phase, can be pumped from a low pressure to a high pressure using a pump such as pump P2 1122. The pumped exergetic fluid, still liquidous, can be warmed to a desired temperature such as ambient temperature. The warming can be accomplished using a heat exchanger such as EXER-HX 1124. The warming of the exergetic fluid can cause the fluid to change state to a gas phase or a vapor phase. The heat that can be provided to the heat exchanger can be sourced from the environment surrounding the heat exchanger. Additionally, and optionally, a heat store can be used to further heat it above ambient temperature. The exergetic fluid, now in a gas phase or vapor phase, can be expanded, where the expanding can result in a low pressure. The expanding can be accomplished using one or more expander engines 1126. The one or more expander engines can be based on one or more multi-stage expanders with inter-heaters. Additional work can be recovered from the one or more expander engines. The expansion can be performed at a temperature, where the temperature can be greater than or equal to ambient temperature. The temperature of the gas tends to decrease as the gas is expanded to a lower pressure. In order to maintain the gas at a desired temperature (e.g., ambient temperature), the expansion of the gas can be accomplished using stages of expanders and inter-heaters. Heat can always be provided from the ambient surroundings, as before. The fluid exiting the expander can be all vapor. The vapor can be cooled in an exergetic heat exchanger XHX2 1120 such that the vapor condenses. As the vapor condenses, the vapor can absorb exergy from the warming liquid air. The low pressure condensate can be provided back to pump P2.

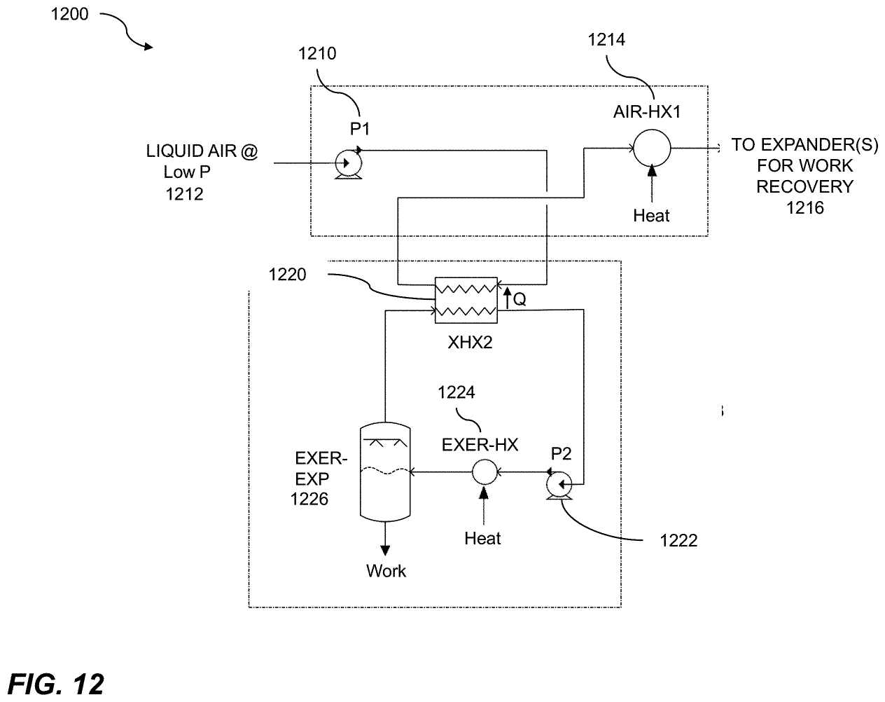

FIG. 12 illustrates a liquid piston-based exergetic loop. Continuing the discussion of a self-contained exergetic loop, an expander, such as a liquid piston expander, can be used in place of a multi-stage expander with the inter-heater described previously. The exergetic loop can be used to warm or transfer heat to a compressed working fluid, thereby causing the exergetic gas to condense. The exergetic loop with liquid piston enables working fluid exergy recovery using hybrid processing. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

A liquid piston-based exergetic loop is shown 1200. A pump P1 1210 can be used to compress or “pump up” a liquid such as liquid or liquefied air. The liquid air can initially be at a low pressure 1212 and can be accessed from a tank, a vessel, etc. The compressing the liquefied air can yield the working fluid at a second pressure greater than the first or initial pressure of the liquefied air. The compressed liquefied air can be provided to a heat exchanger 1220. The heat exchanger can transfer heat from, and exergy to, an exergetic loop (described shortly below). The output of the heat exchanger can be provided to an air heat exchanger 1214. The output of the air heat exchanger can in turn be provided to one or more expanders 1216, such as conventional multi-stage expanders with inter-heating, liquid piston expanders, hybrid expanders, etc., discussed previously. The exergetic loop can comprise a fluid that can be different from the liquefied air. Various fluids such as refrigerants R23 (trifluoroethane), R134A, and R245FA, ethane, propane, butane, pentane, and so on can be used for the exergetic loop. The exergetic loop can include a pump P2 1222 which can be used to compress the refrigerant fluid, a heat exchanger 1224, and a liquid piston expander 1226. In lieu of an inter-heater discussed previously, warming of the contents of the liquid piston can be accomplished using a liquid spray or a solid packing within the pressure vessel of the liquid piston. The liquid piston expander can be used to recover work. The fluid exiting the liquid piston expander can be all vapor. The vapor can be cooled in an exergetic heat exchanger XHX2 1120 such that the vapor condenses. As the vapor condenses, the vapor can absorb exergy from the warming liquid air. The low-pressure condensate can be provided back to pump P2.

A usage example based on the liquid piston expander follows: The exergetic fluid can be pumped from a low pressure to a high pressure using a P2 1222. The pumped exergetic fluid can be warmed to a desired temperature such as an ambient temperature. The warming can be accomplished using a heat exchanger such as EXER-HX 1224. The warming of the exergetic fluid can cause a state change of the fluid to a gas phase or a vapor phase. The heat that can be provided to the heat exchanger can be sourced from the environment surrounding the heat exchanger. The exergetic fluid, now in gas phase or vapor phase, can be expanded, where the expanding can result in a low pressure. The expanding can be accomplished using one or more liquid piston expanders 1226. Additional work can be recovered from the one or more liquid piston expanders. The expansion can be performed at a desired or target temperature, where the temperature can be greater than or equal to ambient temperature. The gas expansion can be made substantially isothermal by using liquid sprays or packings interior to the pressure vessel comprising the liquid piston. The fluid exiting the liquid piston expander can be all vapor. The vapor can be cooled in the exergetic heat exchanger XHX2 1220, enabling the vapor to condense. As the vapor condenses, the vapor can absorb exergy from the warming liquid air. The low-pressure vapor condensate can be provided back to pump P2 1222.

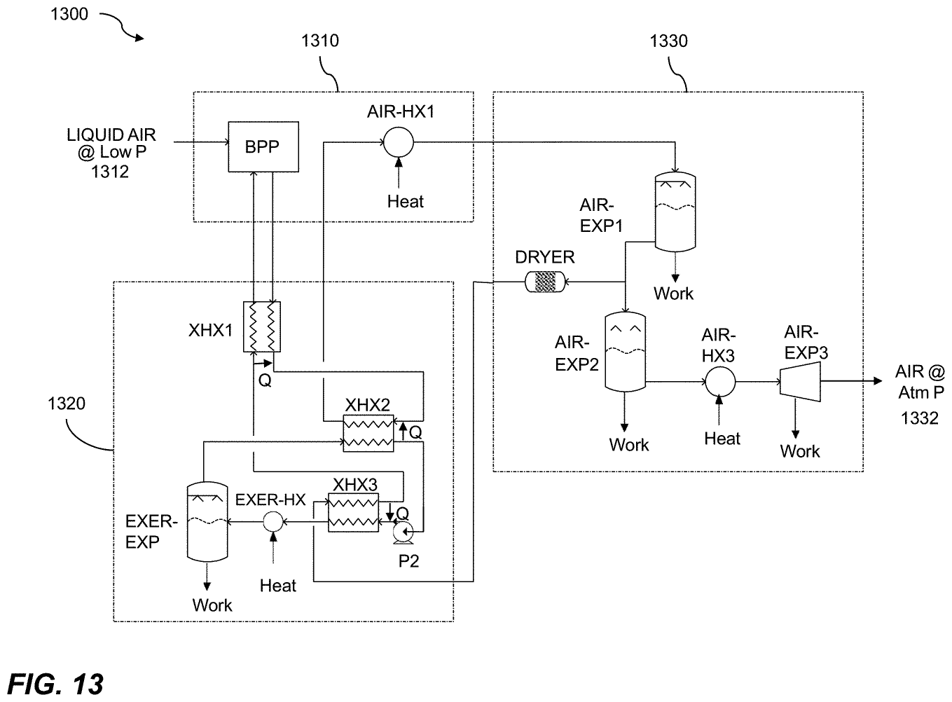

FIG. 13 shows working fluid work recovery using hybrid processing. Discussed previously, a biphasic pressurizer (BPP) can be used to pressurize an accessed supply of a working fluid such as air. In addition, a hybrid multistage liquid piston (LP) can be used to recover work from the compressed working fluid. Further, a portion of the working fluid can be used as an exergetic fluid for enhanced exergy recovery. In further addition, a self-contained exergetic loop, which can be based on a refrigerant such as a Freon™, can be used to enhance exergy recovery. The auto-exergetic loop can be supplemented with a self-contained exergetic loop in tandem to better provide refrigeration. The biphasic pressurizer, hybrid multistage liquid piston, auto-exergetic loop, and the self-contained exergetic loop enable working fluid exergy recovery using hybrid processing. A supply of working fluid at a first pressure and a first temperature is accessed. The working fluid is compressed, wherein the compressing yields the working fluid at a second pressure, wherein the second pressure is greater than the first pressure. The working fluid at the second pressure is warmed to a second temperature using a first heat exchanger, wherein the second temperature is greater than the first temperature, wherein the working fluid at the second temperature is in a gaseous state. The working fluid in a gaseous state is expanded to a third pressure, wherein the expanding is accomplished using a first liquid piston expander. An engine is driven to recover work from the working fluid in a gaseous state, wherein the engine is powered by liquid from the first liquid piston expander.

An example of enhanced exergy recovery from working fluid, using both types of exergetic loops in tandem, is shown 1300. Enhanced exergy recovery from working fluid using both types of exergetic loops in tandem, an auto-exergetic loop using a recycled slipstream, and a self-contained closed loop is shown. Working fluid exergy recovery can include a biphasic pressurizer (BPP) and an air heat exchanger 1310. The biphasic pressurizer (BPP) and air heat exchanger block can access liquid air. The liquid air can be at a low pressure 1312. The liquid air can be stored in a tank, a cryogenic tank, a pressure vessel, etc. The output of the BPP can be provided to one or more heat exchangers, where the one or more heat exchangers can be components of an enhanced exergy recovery scheme 1320 (discussed below). The enhanced exergy recovery scheme can comprise an auto-exergetic scheme and a self-contained exergetic loop in tandem. After passing through the one or more heat exchangers associated with the enhanced exergy recovery schemes, the output of the BPP can be provided to an air heat exchanger such as AIR-HX1. Heat can be provided to the air heat exchanger to ensure the pressurized air is at least at ambient temperature, if not higher. After progressing through the air heat exchanger, the output of the BPP can be provided to a hybrid multistage liquid piston scheme for work extraction.

Heat transfer and enhanced exergy recovery, whether heating or cooling, can be provided by a tandem exergy recovery scheme 1320. The tandem exergy recovery scheme comprises auto-exergy-recovery, where a portion of the working fluid is recycled to be pressurized in the biphasic pressurizer. The auto-exergetic recovery scheme uses the same fluid or gas as compressing components (1310) and expanding components (1330). In embodiments, the auto-exergetic recovery scheme uses liquefied air as the working fluid. The auto-exergetic recovery is based on providing dried gas or fluid to a heat exchanger XHX3, and another heat exchanger XHX1, prior to returning the gas to the biphasic pressurizer for reuse.

The tandem enhanced exergy recovery scheme 1320 further includes a self-contained exergetic loop. The exergetic loop can comprise a fluid different from the working fluid (e.g., the liquefied air used elsewhere). Various fluids can be used for the exergetic loop such as refrigerants R23 (trifluoroethane), R134A, and R245FA, ethane, propane, butane, pentane, mixtures thereof, and so on. The exergetic loop can include a pump P2 which can be used to compress the exergetic fluid, a heat exchanger XHX3, a heat exchanger EXER-HX, a liquid piston expander EXER-EXP for extracting work, and a second heat exchanger XHX2. Warming of the contents of the liquid piston can be accomplished using a heated liquid spray. The liquid piston expander can be used to recover work, and can be used to transfer heat to the compressed liquefied air from the BPP using heat exchanger XHX2. The liquid piston expander can be further used to receive heat from the auto-refrigeration component via heat exchanger XHX3.

The output of the air heat exchanger AIR-HX1 can be provided to a hybrid multistage expander block 1330. The hybrid expander block can include a first liquid piston expander such as AIR-EXP1. Heat can be provided to the liquid piston expander AIR-EXP1 to accomplish warming of the contents of the liquid piston expander. In embodiments, the warming can be accomplished using a liquid spray, where the liquid spray can be heated using heat stored in a thermal store. Work can be recovered from the liquid piston expander. A portion of the output of the liquid piston expander can be directed through a dryer to the auto-exergetic component of the tandem exergy recovery scheme 1320. The dryer can remove vapor such as water vapor from liquefied air, air, etc. The remaining portion of the first liquid piston expander can be provided to a hybrid expander. The hybrid expander can comprise a second liquid piston expander AIR-EXP2, an inter-heater AIR-HX3, and an air expander AIR-EXP3. The second liquid piston expander can be daisy-chained between the first liquid piston expander and the second air heat exchanger (e.g., the inter-heater). Further embodiments include warming the second liquid piston expander to enable substantially isothermal expansion by using a liquid spray. As discussed previously, the expansion by the first liquid piston expander, the second liquid piston expander, and the additional expansion of the inter-heated expander can recover work and additional work from a supply of working fluid. The output of the air expander can comprise a fourth pressure, where the fourth pressure can be substantially one atmosphere 1332. The air at a pressure of substantially one atmosphere can be released to the atmosphere, captured for reuse, stored, and so on.

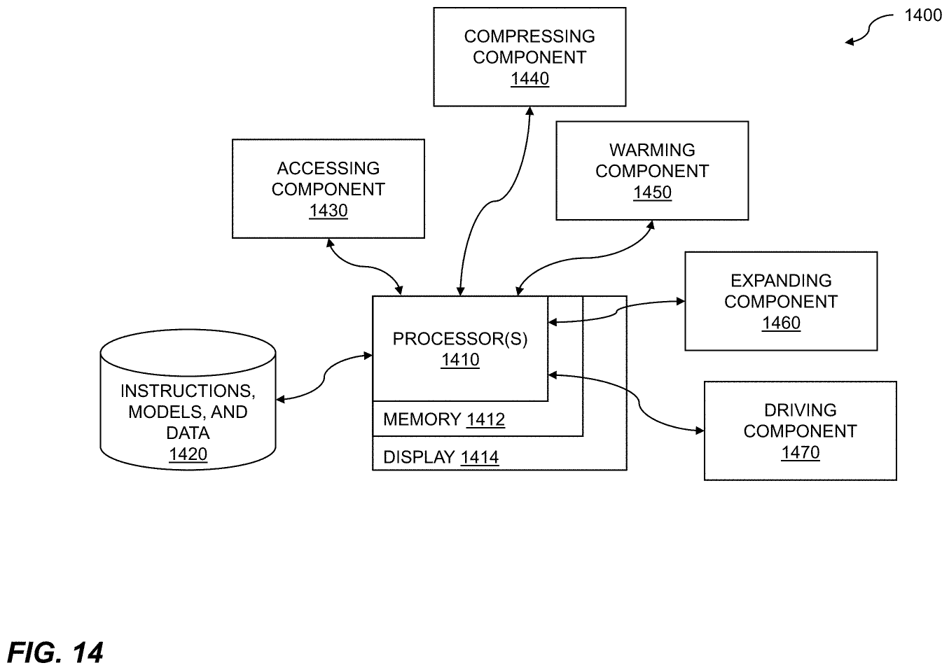

FIG. 14 is a system diagram for working fluid work recovery using hybrid processing. Enabling of a gas processing system is based on working fluid exergy recovery using hybrid processing. A supply of working fluid at a first pressure and a first temperature is accessed. The working fluid is compressed. The compressing yields the working fluid at a second pressure, wherein the second pressure is greater than the first pressure. The working fluid at the second pressure is warmed to a second temperature using a first heat exchanger. The second temperature is greater than the first temperature. The working fluid at the second temperature is in a gaseous state. The working fluid in a gaseous state is expanded to a third pressure, wherein the expanding is accomplished using a first liquid piston expander. The working fluid in a gaseous state in the first liquid piston expander is warmed to enable substantially isothermal expansion. The warming of the working fluid is accomplished using a liquid spray, wherein the liquid spray comprises a liquid spray heated by heat stored in a thermal store. The heat stored in the thermal store was generated by a process that produced the supply of working fluid. An engine is driven to recover work from the working fluid in a gaseous state, wherein the engine is powered by liquid from the first liquid piston expander. The gas from the first liquid piston expander that was heated by the second heat exchanger to a fourth pressure is additionally expanded. The additionally expanding the gas from the first liquid piston expander that was heated by the second heat exchanger to a fourth pressure is used to recover additional work from the supply of working fluid. The additionally expanding the gas is accomplished using an adiabatic expander. The gas that was liquefied is used to perform work. The working fluid and the stored heat are used to provide a variety of functions which include energy storage, providing heat, and providing cooling.

The system 1400 can include one or more processors 1410 and a memory 1412 which stores instructions. The memory 1412 is coupled to the one or more processors 1410, wherein the one or more processors 1410 can execute instructions stored in the memory 1412. The memory 1412 can be used for storing instructions, for storing databases for liquefaction systems, for storing switching valve and non-return valve configurations, and the like. Information regarding the working fluid exergy recovery using a hybrid processing system can be shown on a display 1414 connected to the one or more processors 1410. The display can comprise a television monitor, a projector, a computer monitor (including a laptop screen, a tablet screen, a netbook screen, and the like), a smartphone display, a mobile device, or another electronic display.

The system 1400 includes instructions, models, and data 1420. The data can include information on gas liquefaction systems; information on working fluid exergy recovery; information on the controlling of switching valves, non-return valves, or smart valves; metadata about liquefaction; metadata about exergy recovery; and the like. In embodiments, the instructions, models, and data 1420 are stored in a networked database, where the networked database can be a local database, a remote database, a distributed database, and so on. The instructions, models, and data 1420 can include instructions for compressing the working fluid to yield the working fluid at a second pressure. The instructions, models, and data can include instructions for adiabatically expanding a gas using an adiabatic expander. The instructions, models, and data can further include instructions for warming the working fluid. The warming can include warming the working fluid at the second pressure to a second temperature using a first heat exchanger. The second temperature can be greater than the first temperature, and the working fluid at the second temperature can be in a gaseous state. The instructions, models, and data can include instructions for expanding the working fluid in a gaseous state to a third pressure. The expanding can be accomplished using a first liquid piston expander. Embodiments further include warming the working fluid in a gaseous state in the first liquid piston expander to enable substantially isothermal expansion. The warming can be accomplished using a heat exchanger, injecting a liquid, and so on. In embodiments, the warming can be accomplished using a liquid spray. The liquid spray can be heated using heat, such as heat from compression, stored in a thermal store. The instructions, models, and data can include instructions for driving an engine to recover work from the working fluid in a gaseous state. The engine can include a turbine, a pump-turbine, and so on. The engine can be powered by liquid from the first liquid piston expander.

The system 1400 includes an accessing component 1430. The accessing component 1430 can access a supply of working fluid at a first pressure and a first temperature. The working fluid that is accessed can be obtained from working fluid storage such as a pressure vessel, a cryogenic tank, and so on. Cryogenic liquid storage, such as a working fluid storage, can be accomplished by storing the cryogenic liquid in cryogenic container such as a double-walled, evacuated container. In embodiments, the cryogenic tank can be used to store one or more cryogenic liquid columns. The system 1400 includes a compressing component 1440. The compressing component can compress the working fluid. The compressing yields the working fluid at a second pressure, wherein the second pressure is greater than the first pressure. In embodiments, the compressing the working fluid can be accomplished adiabatically to yield the compressed gas at a second pressure. Recall that for an adiabatic process, neither heat nor mass is transferred between the adiabatic process and the environment that surrounds the process. The compressing can be accomplished using a variety of techniques including a pump, piston, a compressor, a liquid piston, and so on. In embodiments, the compressing a working fluid in a gaseous state adiabatically can be accomplished using two or more compressing stages. The compressing stages can be substantially similar compressing stages or substantially different compressing stages.

The system 1400 includes a warming component 1450. The warming component 1450 can warm the liquefied gas at the second pressure to a second temperature using a first heat exchanger, wherein the second temperature is greater than the first temperature. The working fluid at the second temperature can be in a gaseous state. Discussed above and throughout, a variety of techniques can be used to warm the working fluid. The warming the working fluid can counter the cooling attributable to the expansion, can be used to set a temperature for the gas, and the like. Embodiments include warming the working fluid in a gaseous state in the first liquid piston expander to enable substantially isothermal expansion. The warming can be accomplished by warming a vessel in which the working fluid is held, injecting heat into the vessel, and so on. In embodiments, the warming can be accomplished using a liquid spray. The liquid spray can be introduced to the working fluid. In embodiments, the liquid spray can include a liquid spray heated by heat stored in a thermal store. Discussed previously, heat from compression or another source can be captured and stored in the thermal store. The stored heat can be retrieved from the thermal store and used to heat the thermal spray.

The system 1400 includes an expanding component 1460. The expanding component 1460 can expand the working fluid in a gaseous state to a third pressure. A variety of gas expansion techniques, such as a turbo-expander, can be used to expand the gas. In embodiments, the expanding can be accomplished using a first liquid piston expander. More than one liquid piston expander can be used to the expanding. Further embodiments can include additionally expanding the gas from the first liquid piston expander that was heated by the second heat exchanger to a fourth pressure. Various types of expanders can be used to accomplish the additionally expanding the gas. In embodiments, the additionally expanding the gas can be accomplished using an adiabatic expander. The liquid pistons can be coupled using a variety of techniques such as daisy-chaining techniques. Additional liquid pistons can be included. Further embodiments include daisy-chaining a second liquid piston expander between the first liquid piston expander and the second heat exchanger.

The system 1400 includes a driving component 1470. The driving component 1450 can drive an engine to recover work from the working fluid in a gaseous state, wherein the engine is powered by liquid from the first liquid piston expander. The engine can include a turbine, a pump-turbine, a liquid piston engine, and so on. The work that is recovered can be used to convert stored energy such as thermal energy to another energy form such as electrical energy, mechanical energy, and so on. The driving can include driving an additional engine. Embodiments further include additionally expanding the gas from the first liquid piston expander that was heated by the second heat exchanger to a fourth pressure. The liquid piston expander can include an additional LP expander such as a second liquid piston expander. In embodiments, the additionally expanding the gas from the first liquid piston expander that was heated by the second heat exchanger to a fourth pressure is used to recover additional work from the supply of working fluid. The expanding the gas from the first liquid piston expander can be accomplished isothermally by injecting heat. In embodiments, heat can be injected using a warming liquid spray. The liquid spray can be heated by applying heat due to compression that was previously extracted and stored in a thermal store. In embodiments, the additionally expanding the gas is accomplished using an adiabatic expander.

The system 1400 can include a system for gas processing comprising: a memory which stores instructions; one or more processors coupled to the memory wherein the one or more processors, when executing the instructions which are stored, are configured to: access a supply of working fluid at a first pressure and a first temperature; compress the working fluid, wherein the compressing yields the working fluid at a second pressure, wherein the second pressure is greater than the first pressure; warm the working fluid at the second pressure to a second temperature using a first heat exchanger, wherein the second temperature is greater than the first temperature, wherein the working fluid at the second temperature is in a gaseous state; expand the working fluid in a gaseous state to a third pressure, wherein the expanding is accomplished using a first liquid piston expander; and drive an engine to recover work from the working fluid in a gaseous state, wherein the engine is powered by liquid from the first liquid piston expander.

Further disclosed is a computer program product embodied in a non-transitory computer readable medium for gas processing, the computer program product comprising code which causes one or more processors to perform operations of: accessing a supply of working fluid at a first pressure and a first temperature; compressing the working fluid, wherein the compressing yields the working fluid at a second pressure, wherein the second pressure is greater than the first pressure; warming the working fluid at the second pressure to a second temperature using a first heat exchanger, wherein the second temperature is greater than the first temperature, wherein the working fluid at the second temperature is in a gaseous state; expanding the working fluid in a gaseous state to a third pressure, wherein the expanding is accomplished using a first liquid piston expander; and driving an engine to recover work from the working fluid in a gaseous state, wherein the engine is powered by liquid from the first liquid piston expander.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable, and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for gas processing comprising:
accessing a supply of working fluid at a first pressure and a first temperature;
compressing the working fluid, wherein the compressing yields the working fluid at a second pressure, wherein the second pressure is greater than the first pressure;
warming the working fluid at the second pressure to a second temperature using a first heat exchanger, wherein the second temperature is greater than the first temperature, wherein the working fluid at the second temperature is in a gaseous state;
expanding the working fluid in a gaseous state to a third pressure, wherein the expanding is accomplished using a first liquid piston expander; and
driving an engine to recover work from the working fluid in a gaseous state, wherein the engine is powered by liquid from the first liquid piston expander.

2. The method of claim 1 further comprising warming the working fluid in a gaseous state in the first liquid piston expander to enable substantially isothermal expansion.

3. The method of claim 2 wherein the warming is accomplished by a plurality of liquid piston expanders operating in parallel, using expander wall conduction heat transfer.

4. The method of claim 3 wherein the plurality of liquid piston expanders each has an inner diameter of less than two inches.

5. The method of claim 3 wherein the warming is accomplished using heat stored in structured packing associated with the plurality of liquid piston expanders.

6. The method of claim 1 further comprising warming the working fluid in a gaseous state that was expanded to a third pressure in a second heat exchanger, wherein the second heat exchanger is fed by gas from the first liquid piston expander.

7. The method of claim 6 wherein the second heat exchanger uses heat stored in a thermal store.

8. The method of claim 7 wherein the heat stored in the thermal store was generated by a process that produced the supply of working fluid.

9. The method of claim 6 further comprising additionally expanding the gas from the first liquid piston expander that was heated by the second heat exchanger to a fourth pressure.

10. The method of claim 9 wherein the additionally expanding the gas from the first liquid piston expander that was heated by the second heat exchanger to a fourth pressure is used to recover additional work from the supply of working fluid.

11. The method of claim 9 wherein the additionally expanding the gas is accomplished using an adiabatic expander.

12. The method of claim 9 further comprising daisy-chaining a second liquid piston expander between the first liquid piston expander and the second heat exchanger.

13. The method of claim 1 further comprising pressurizing an auxiliary gas, wherein the auxiliary gas is mixed with the supply of working fluid.

14. The method of claim 13 wherein the auxiliary gas comprises cooled environmental air.

15. The method of claim 13 wherein the auxiliary gas is sourced by splitting off a portion of the working fluid in the gaseous state expanded to a third pressure.

16. The method of claim 15 wherein the auxiliary gas is dried before it is mixed with the supply of working fluid.

17. The method of claim 16 wherein the pressurizing an auxiliary gas is performed by two or more liquid piston compressors working reciprocally.

18. The method of claim 13 further comprising precooling the auxiliary gas that is mixed with the supply of working fluid while warming the auxiliary gas and working fluid mixture using a third heat exchanger.

19. The method of claim 1 further comprising heating the working fluid at the second pressure before it enters the first liquid piston expander.

20. The method of claim 19 further comprising expanding the working fluid in a gaseous state at the second pressure is accomplished adiabatically.

21. The method of claim 1 further comprising preheating the working fluid at a second pressure using an additional heat exchanger that is warmed by an exergetic loop.

22. The method of claim 21 wherein the exergetic loop comprises two or more expander stages with inter-stage heating elements.

23. A computer program product embodied in a non-transitory computer readable medium for gas processing, the computer program product comprising code which causes one or more processors to perform operations of:
accessing a supply of working fluid at a first pressure and a first temperature;
compressing the working fluid, wherein the compressing yields the working fluid at a second pressure, wherein the second pressure is greater than the first pressure;
warming the working fluid at the second pressure to a second temperature using a first heat exchanger, wherein the second temperature is greater than the first temperature, wherein the working fluid at the second temperature is in a gaseous state;
expanding the working fluid in a gaseous state to a third pressure, wherein the expanding is accomplished using a first liquid piston expander; and
driving an engine to recover work from the working fluid in a gaseous state, wherein the engine is powered by liquid from the first liquid piston expander.

24. A system for gas processing comprising:
a memory which stores instructions;
one or more processors coupled to the memory wherein the one or more processors, when executing the instructions which are stored, are configured to:
access a supply of working fluid at a first pressure and a first temperature;
compress the working fluid, wherein the compressing yields the working fluid at a second pressure, wherein the second pressure is greater than the first pressure;
warm the working fluid at the second pressure to a second temperature using a first heat exchanger, wherein the second temperature is greater than the first temperature, wherein the working fluid at the second temperature is in a gaseous state;
expand the working fluid in a gaseous state to a third pressure, wherein the expanding is accomplished using a first liquid piston expander; and
drive an engine to recover work from the working fluid in a gaseous state, wherein the engine is powered by liquid from the first liquid piston expander.
